(19) United States
(12) Patent Application Publication
(10) Pub. No.: US 2023/0409280 A1
(43) Pub. Date: Dec. 21, 2023

(54) Techniques for Off-Net Synchrony Group Formation

(71) Applicant: Sonos, Inc., Santa Barbara, CA (US)

(72) Inventors: Brenda Stefani, Andover, MA (US); Christopher Babroski, Allston, MA (US); Da-Hai Ding, Lexington, MA (US); Gary Anthony Matulis, Santa Barbara, CA (US); Robert James Bermani, Danvers, MA (US); Zhaoyun Huang, Sudbury, MA (US); Meng Wang, Woburn, MA (US); Joe Jingzhong Zheng, Lynnwood, WA (US); Cheng Lu, Malden, MA (US)

(21) Appl. No.: 18/334,830

(22) Filed: Jun. 14, 2023

Related U.S. Application Data
(60) Provisional application No. 63/352,862, filed on Jun. 16, 2022.

(51) Int. Cl. G06F 3/16

(52) U.S. Cl. CPC G06F 3/165; H04W 4/80

(57) ABSTRACT

A playback device is provided. The playback device includes a processor; an audio interface connected to the processor and configured to output audio; a communication interface connected to the processor and configured to communicate over a network; a memory operably connected to the processor; and instructions stored in the memory. The instructions are executable by the processor such that the playback device can receive an audio stream via a first wireless network; play back, via the audio interface, audio content based on the audio stream; while receiving the audio stream via the first wireless network, transmit an indication of availability of the audio stream; detect a request, from another playback device, to play back the audio stream; establish a second wireless network; detect that the other playback device has joined the second wireless network; and transmit the audio stream to the other playback device via the second wireless network.

### CROSS-REFERENCE TO RELATED APPLICATION

This application claims the benefit of U.S. Provisional Patent Application 63/352,862 (filed 16 Jun. 2022), the entirety of which is hereby incorporated by reference herein.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when Sonos, Inc. began development of a new type of playback system. Sonos then filed one of its first patent applications in 2003, entitled “Method for Synchronizing Audio Playback between Multiple Networked Devices”, and began offering its first media playback systems for sale in 2005. The SONOS Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIGS. 1I-1L are schematic diagrams of corresponding media playback system zones.

FIG. 1M is a schematic diagram of media playback system areas.

FIG. 2A is a front isometric view of a playback device configured in accordance with aspects of the disclosed technology.

FIG. 2B is a front isometric view of the playback device of FIG. 2A without a grille.

FIG. 2C is an exploded view of the playback device of FIG. 2A.

FIG. 3A is a front view of a network microphone device configured in accordance with aspects of the disclosed technology.

FIG. 3B is a side isometric view of the network microphone device of FIG. 3A.

FIG. 3C is an exploded view of the network microphone device of FIGS. 3A and 3B.

FIG. 3D is an enlarged view of a portion of FIG. 3B.

FIG. 3E is a block diagram of the network microphone device of FIGS. 3A-3D.

FIG. 3F is a schematic diagram of an example voice input.

FIGS. 4A-4D are schematic diagrams of a control device in various stages of operation in accordance with aspects of the disclosed technology.

FIG. 5 is a front view of a control device.

FIG. 6 is a message flow diagram of a media playback system.

FIGS. 7A and 7B illustrate a device and data flow overview of multiple playback devices forming a synchrony group and simultaneously streaming audio content, in accordance with at least one embodiment of the present disclosure.

FIGS. 7C and 7D illustrate an alternate device and data flow overview of multiple playback devices forming a synchrony group and simultaneously streaming audio content, in accordance with at least one embodiment of the present disclosure.

FIG. 8A illustrates an example process flow performed by a primary playback device in providing an audio stream to a secondary playback device, in accordance with at least one embodiment of the present disclosure.

FIG. 8B illustrates a more detailed process flow performed by a primary playback device in providing an audio stream to a secondary playback device, in accordance with at least one embodiment of the present disclosure.

FIG. 9A illustrates an example process flow performed by a secondary playback device in obtaining an audio stream from a primary playback device, in accordance with at least one embodiment of the present disclosure.

FIG. 9B illustrates a more detailed process flow performed by a secondary playback device in obtaining an audio stream from a primary playback device, in accordance with at least one embodiment of the present disclosure.

FIG. 10A illustrates a sequence diagram showing interactions between a plurality of playback devices during simultaneous streaming of audio content, in accordance with at least one embodiment of the present disclosure.

FIG. 10B illustrates an alternative sequence diagram showing interactions between an external controller device and a plurality of playback devices during simultaneous streaming of audio content, in accordance with at least one embodiment of the present disclosure.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Sonos has a long history of creating innovative wireless audio products that provide an easy experience for end users. In particular, Sonos has been lauded by critics and end users alike for creating a wireless multiroom speaker system that allows users to effortlessly extend audio playback across any number of wireless playback devices in a space (for example, a home, an office, and the like). For instance, when on-net (for example, at a home or other location with an established network that the playback devices normally connect to), a user can start playing music on a first playback device (for example, via various mechanisms such as voice control, a controller application, a button press, and other similar mechanisms) and, over time, can group one or more additional playback devices with that first playback device to form a synchrony group that plays back the music synchronously. For instance, a user can start music playback on a first playback device and cause a second playback device to join in synchronous playback of the music simply by pressing and holding the play/pause button on the second playback device. In the instance where there are two or more existing playback devices on the network playing different audio streams, the second playback device can cycle through all the audio stream options on subsequent press-and-hold inputs of the play/pause button. For example, a given playback device may start by joining in play back of a first audio stream from a first existing playback device, detect a subsequent press-and-hold of the play/pause button, and proceed to join and play back a second audio stream from a second existing playback device. Additionally or alternatively, a user can expand or otherwise modify a synchrony group using a controller application simply by activating the grouping button and selecting which players should be added to or removed from the synchrony group.

Aspects of the present disclosure manifest an appreciation that end users, who are already familiar with grouping via press-and-hold on the player and/or in a controller application, would benefit from the extension of such familiar grouping functionality to off-net scenarios (for example, in areas where the playback device is operating away from the existing wireless network(s) that the playback device would normally connect to such as at the beach, at a park, on a hike, and the like). In such examples, a user can start playing audio over a BLUETOOTH Classic connection to a first playback device, then simply press-and-hold the play/pause button (or other similar user input) on another playback device to automatically have the second playback device join the first playback device for synchronous playback of the audio via the BLUETOOTH Classic stream.

The systems and methods as described herein implement a scheme that leverages BLUETOOTH LOW ENERGY (BLE) messages to negotiate when a playback device is to function as a soft access point (AP) (sometimes referred to as a “software AP”) and/or create a network for other playback devices to join. At a high level, a first playback device that is receiving a BLUETOOTH Classic stream can advertise (for example, via broadcasting a BLE message) that it is receiving an audio stream and whether it is currently functioning as a soft AP. When a second playback device detects, for example, a press-and-hold of its play/pause button (or another similar user input), the second playback device can perform a scan for any advertisements (for example, broadcast messages) from other playback devices. If the second playback device finds a playback device with a stream or multiple playback devices with different streams, the second playback device can select one of the audio streams to join.

In some examples, if the playback device as identified by the second playback device has already created a network and/or is functioning as a soft AP, the second playback device can join the network of the identified playback device to access the audio stream. Otherwise, the second playback device can establish a BLE connection with the identified playback device and request, via the BLE connection, for the identified player to operate as a soft AP and create a wireless network over which to transmit the audio stream. The identified playback device can start a network and provide a response to the second playback device indicating that the network has been created as well as any credential information required to join the network. The second playback device can join the network created by the identified playback device to obtain the audio stream for synchronous playback. Such an implementation provides for a simple and efficient process for users to wirelessly connect and synchronously stream audio content between multiple playback devices in an off-net situation.

In some embodiments, for example, a first playback device can be configured to function as a soft AP for additional playback devices. In some implementations, the first playback device can include a processor, an audio output interface operatively connected to the processor and configured to output audio, and one or more communication interfaces operably connected to the processor and configured to facilitate communication over at least one network. In some examples, the playback device can be configured to receive an audio stream from an external device such as a smartphone via a first wireless network and playback, via the audio output interface, audio content based on the audio stream. While receiving the audio stream via the first wireless network, the playback device can further transmit an indication of the availability of the audio stream. As noted above, such an indication can be transmitted as a BLE message to conserve power at the first playback device. In response to the transmission, the playback device can detect a request to play back the audio stream from a second playback device. Based upon detecting the request, the first playback device can establish a second wireless network, detect that the second playback device has joined the second wireless network, and transmit the audio stream to the second playback device via the second wireless network for synchronous playback.

While some examples described herein may refer to functions performed by given actors such as “users”, “listeners”, and/or other entities, it should be understood that such references are for purposes of explanation only. The claims should not be interpreted to require action by any such example actor unless explicitly required by the language of the claims themselves.

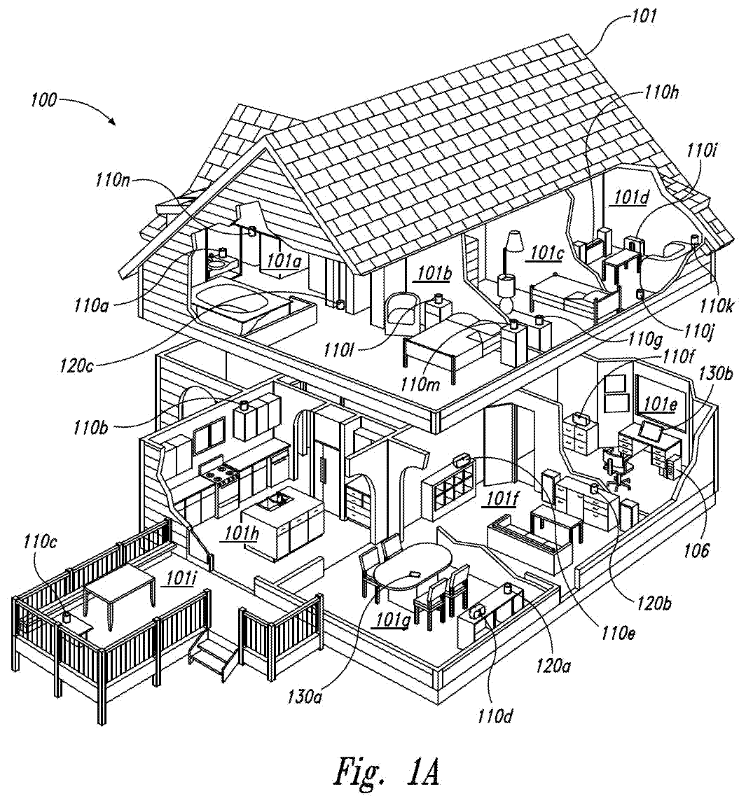

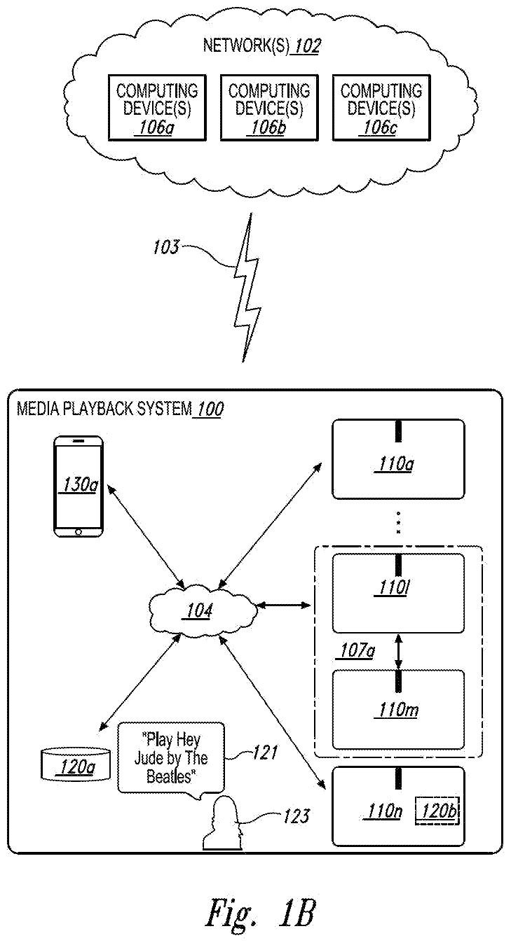

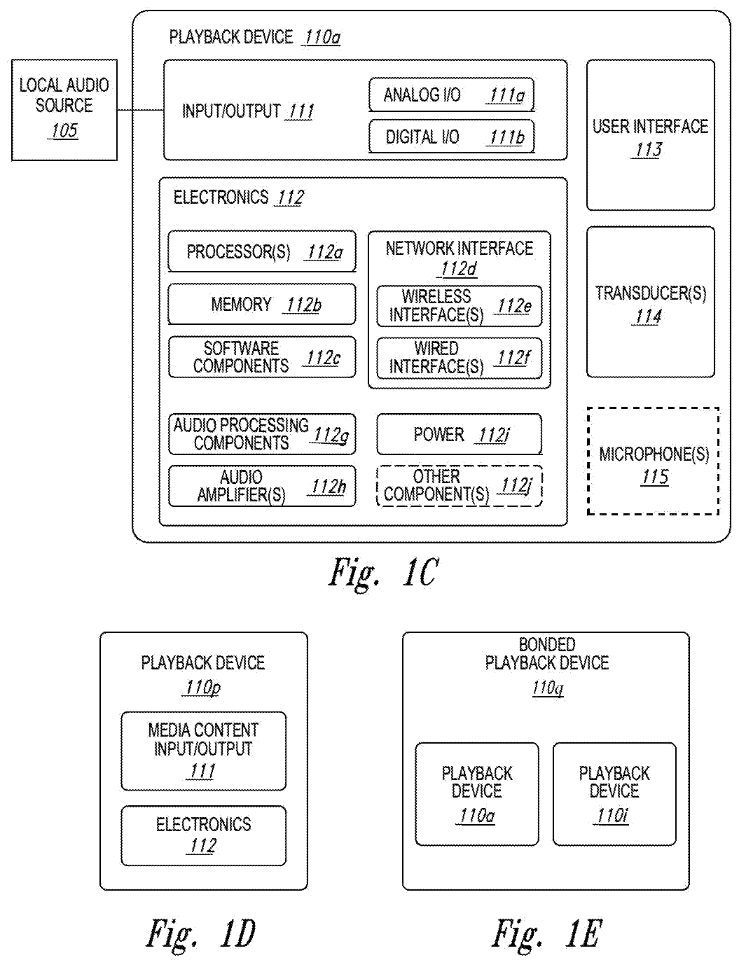

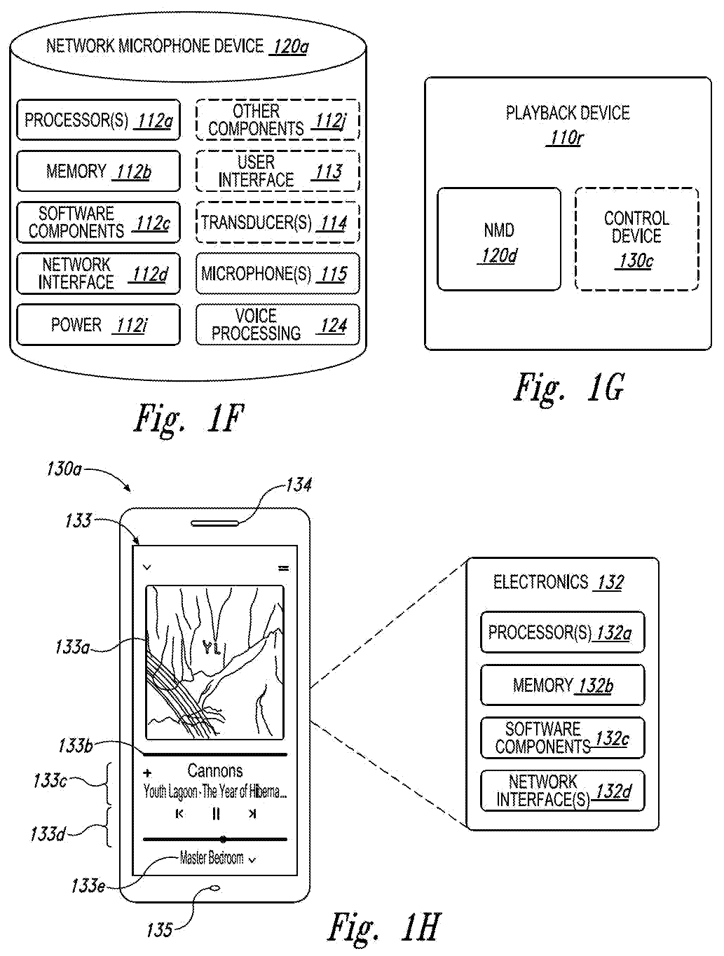

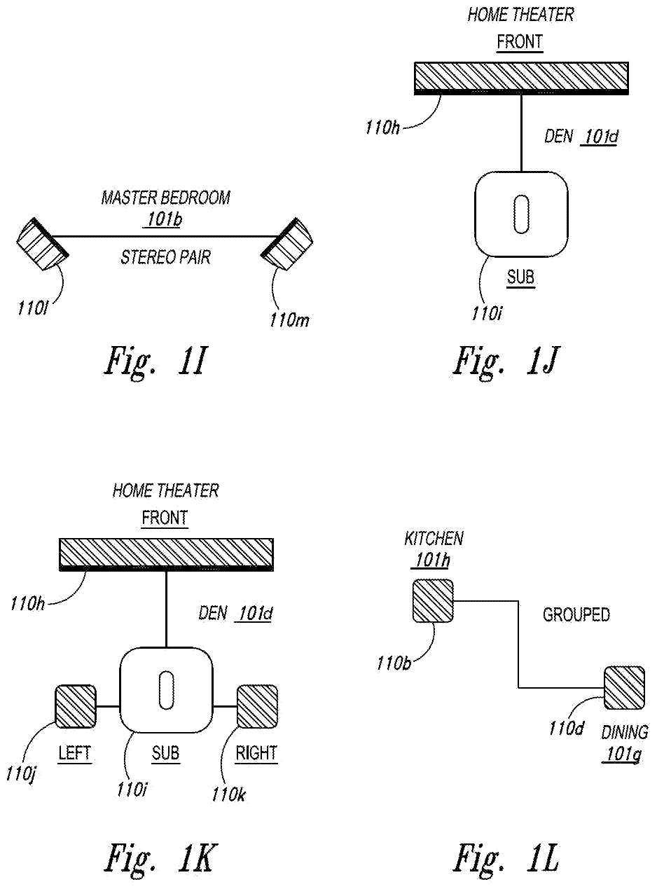

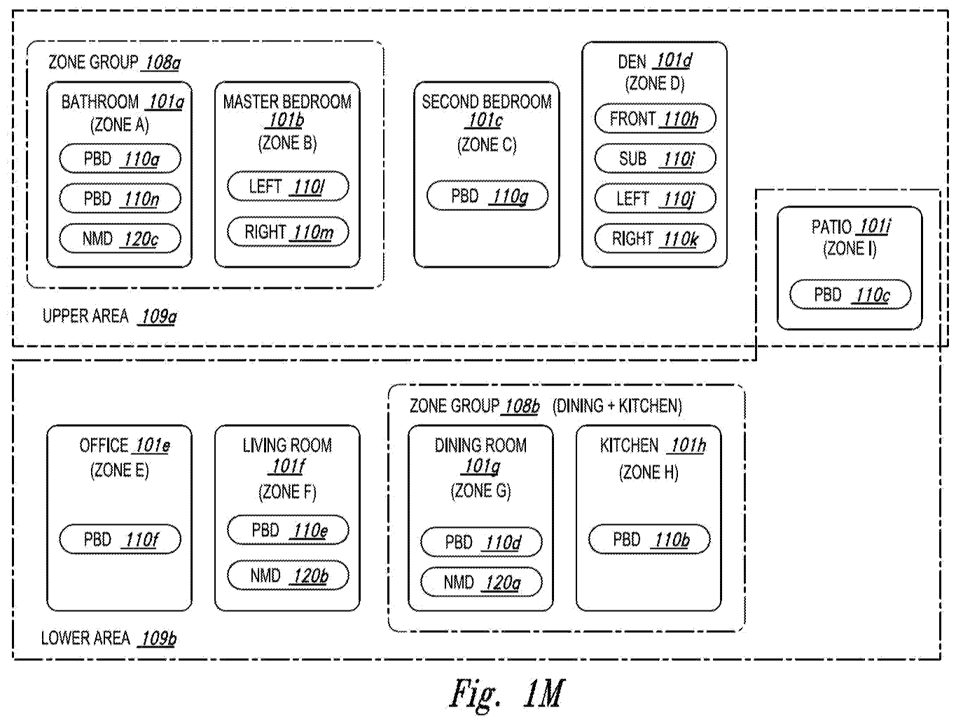

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles, and other features shown in the Figures are merely illustrative of particular embodiments of the disclosed technology. Accordingly, other embodiments can have other details, dimensions, angles, and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices, etc.) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation, etc.). In some embodiments, for example, the media playback system 100 is configured to play back audio from a first playback device (e.g., the playback device 110a) in synchrony with a second playback device (e.g., the playback device 110b). Interactions between the playback devices 110, NMDs 120, and/or control devices 130 of the media playback system 100 configured in accordance with the various embodiments of the disclosure are described in greater detail below with respect to FIGS. 1B-6.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane, etc.), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B, 1E, and 1I-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 (filed 1 Apr. 2004; entitled “System and method for synchronizing operations among a plurality of independently clocked digital data processing devices”), which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication networks, and/or other suitable data transmission protocol networks), etc. The cloud network 102 is configured to deliver media content (e.g., audio content, video content, photographs, social media content, etc.) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WIFI network, a BLUETOOTH network, a Z-Wave network, a ZIGBEE network, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WIFI” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 gigahertz (GHz), 5 GHz, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household or commercial facility communication network (e.g., a household or commercial facility WIFI network). In some embodiments, the links 103 and the network 104 comprise one or more of the same networks. In some aspects, for example, the links 103 and the network 104 comprise a telecommunication network (e.g., an LTE network, a 5G network, etc.). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud servers that host cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length, etc.) and other associated information (e.g., URIs, URLs, etc.) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1I-1M.

The media playback system 100 includes the NMDs 120a and 120b, each comprising one or more microphones configured to receive voice utterances from a user. In the illustrated embodiment of FIG. 1B, the NMD 120a is a standalone device and the NMD 120b is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS, AMAZON, GOOGLE, APPLE, MICROSOFT, etc.). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WIFI, BLUETOOTH, or another suitable communication link. In certain embodiments, the analog I/O 111a and the digital I/O 111b comprise interfaces (e.g., ports, plugs, jacks, etc.) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a BLUETOOTH connection, an ad hoc wired or wireless communication network, and/or another suitable communication link). The local audio source 105 can comprise, for example, a mobile device (e.g., a smartphone, a tablet, a laptop computer, etc.) or another suitable audio component (e.g., a television, a desktop computer, an amplifier, a phonograph (such as an LP turntable), a Blu-ray player, a memory storing digital media files, etc.). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens, etc.), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases, etc.).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a—c (FIG. 18)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone, etc.).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds, etc.) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receive and process the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WIFI, BLUETOOTH, LTE, etc.). In some embodiments, the network interface 112d optionally includes a wired interface 112f (e.g., an interface or receptacle configured to receive a network cable such as an Ethernet, USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 exclude the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DACs), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omit the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers 112h include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G amplifiers, class-H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 include a single one of the amplifiers 112h configured to output amplified audio signals to a plurality of the transducers 114. In some other embodiments, the electronics 112 omit the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, Sonos, Inc. presently offers (or has offered) for sale certain playback devices including, for example, a “SONOS ONE”, “PLAY:1”, “PLAY:3”, “PLAY:5”, “PLAYBAR”, “PLAYBASE”, “CONNECT:AMP”, “CONNECT”, “AMP”, “PORT”, and “SUB”. Other suitable playback devices may additionally or alternatively be used to implement the playback devices of example embodiments disclosed herein. Additionally, one of ordinary skill in the art will appreciate that a playback device is not limited to the examples described herein or to Sonos product offerings. In some embodiments, for example, one or more playback devices 110 comprise wired or wireless headphones (e.g., over-the-ear headphones, on-ear headphones, in-ear earphones, etc.). In other embodiments, one or more of the playback devices 110 comprise a docking station and/or an interface configured to interact with a docking station for personal mobile media playback devices. In certain embodiments, a playback device may be integral to another device or component such as a television, an LP turntable, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

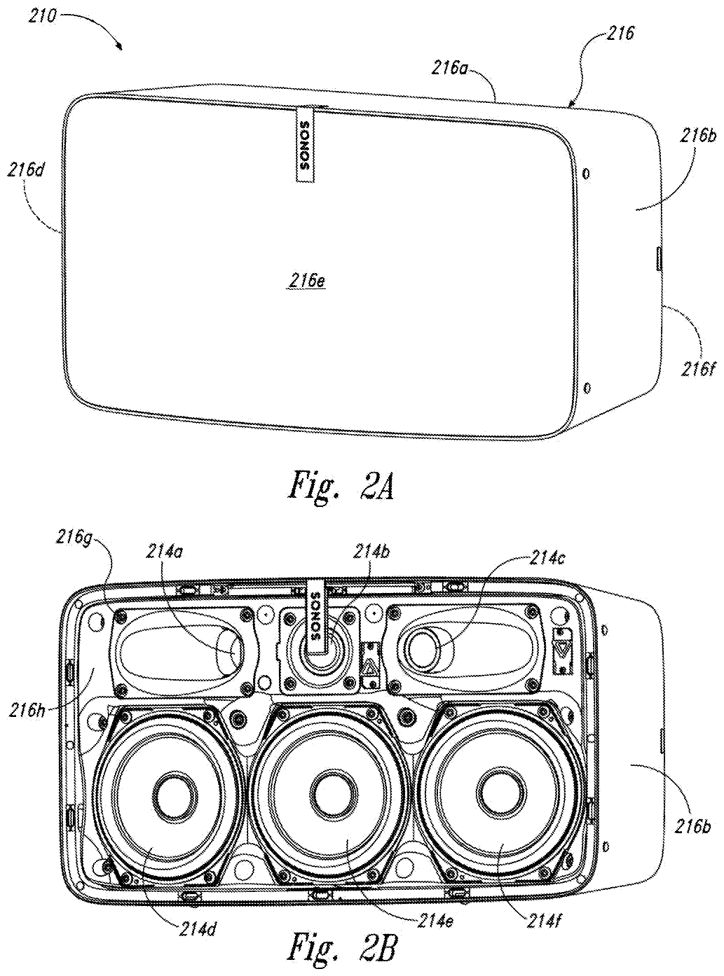

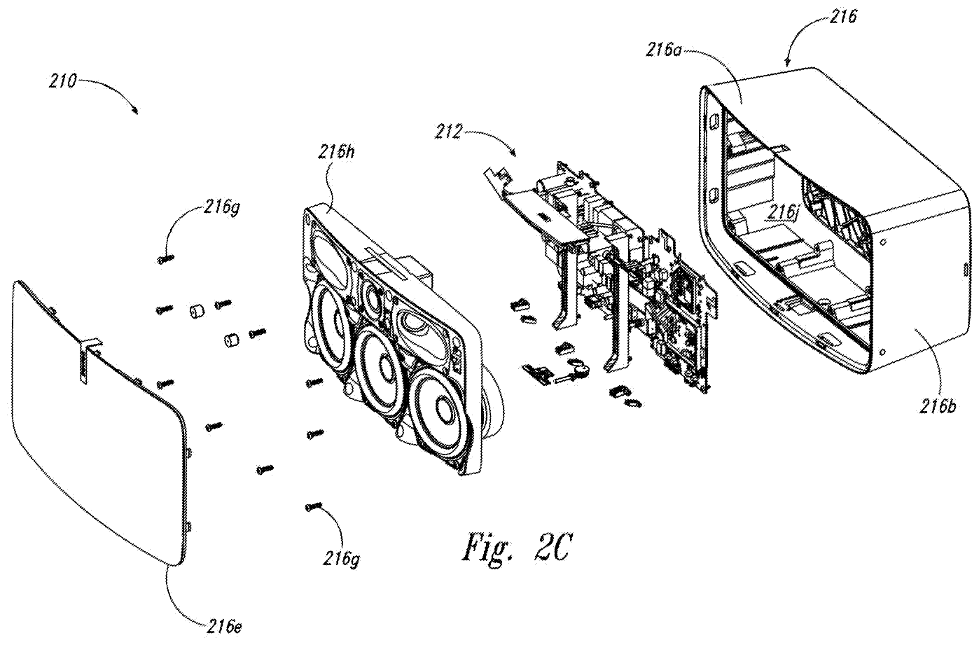

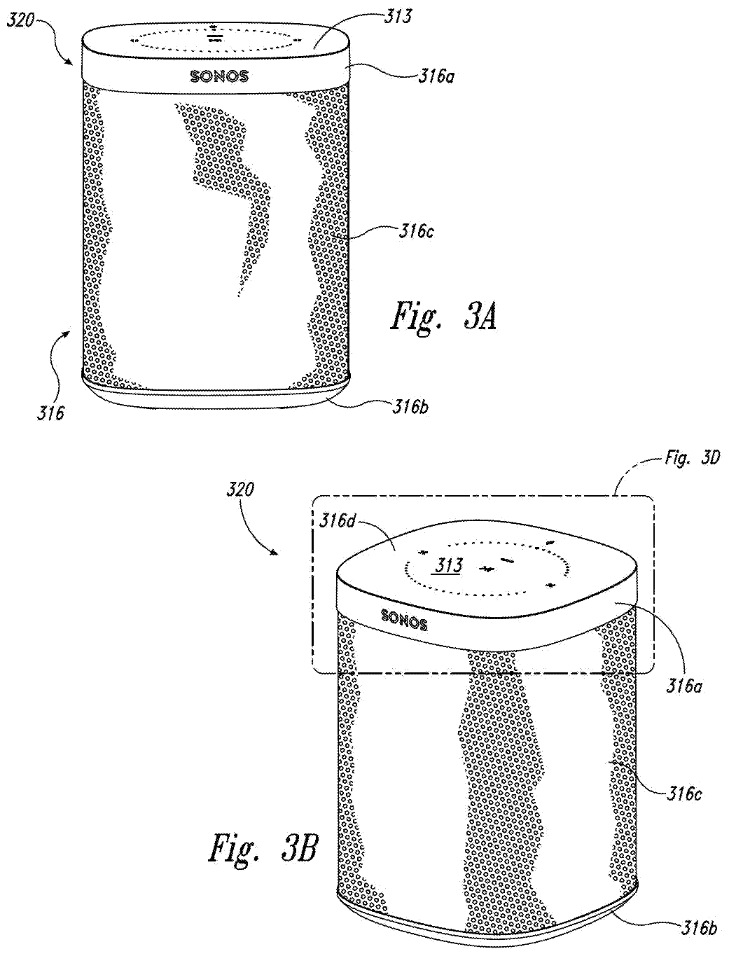

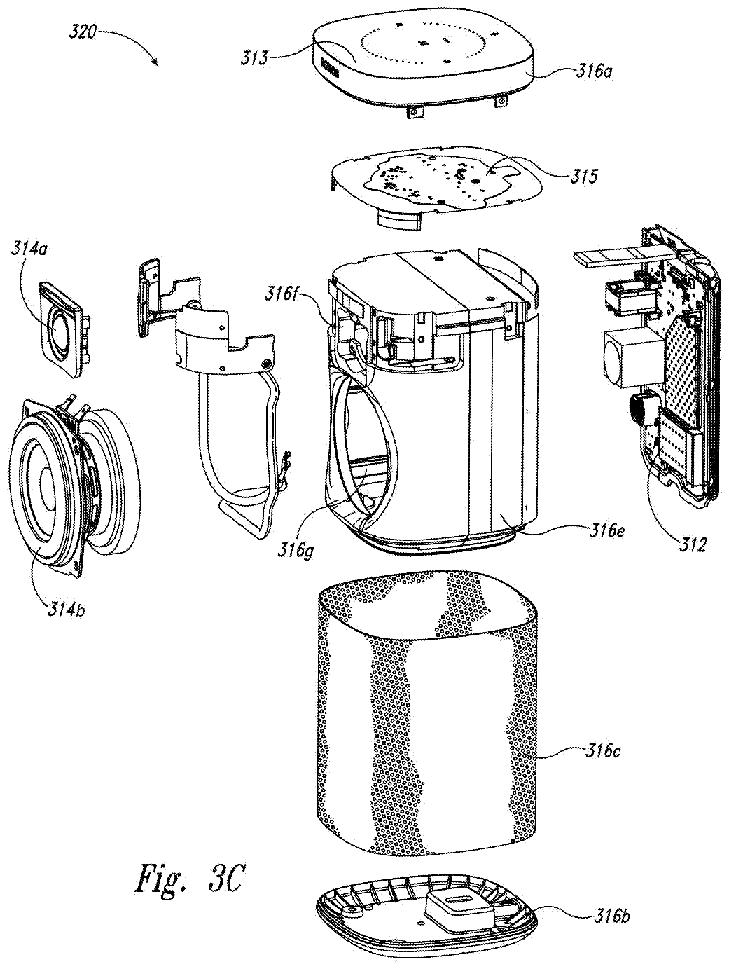

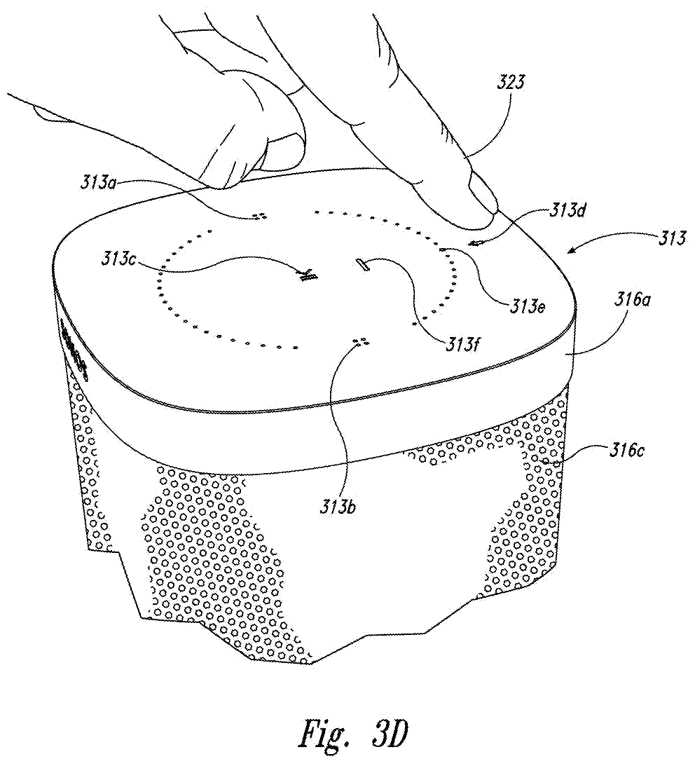

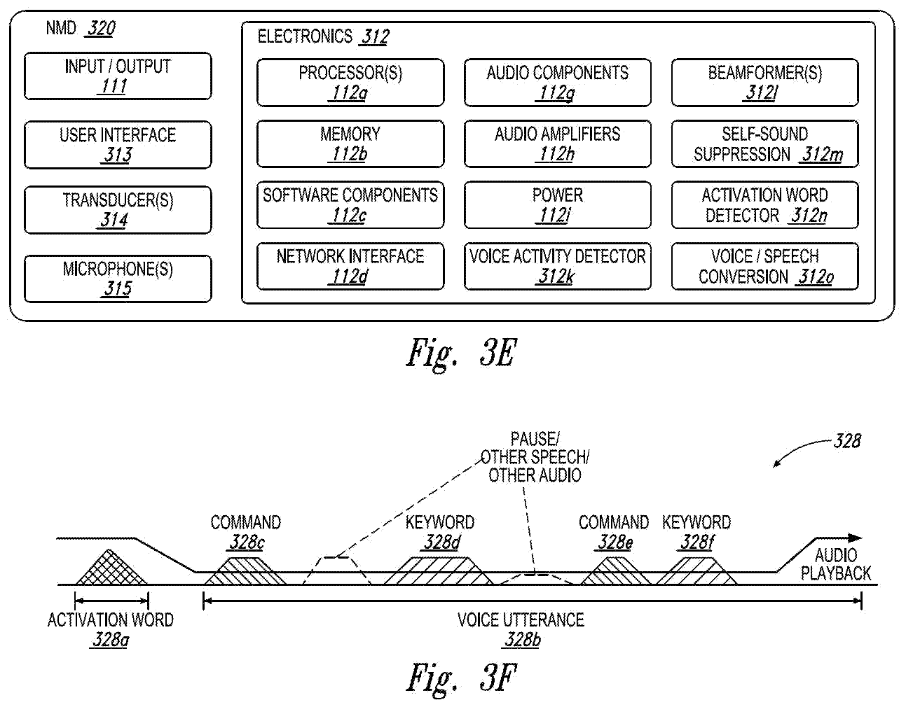

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 18). In some embodiments, for example, the playback device 110a is a full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device. Additional playback device embodiments are described in further detail below with respect to FIGS. 2A-3D.

c. Suitable Network Microphone Devices (NMDs)

FIG. 1F is a block diagram of the NMD 120a (FIGS. 1A and 18). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 112h, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1C. In some aspects, for example, the NMD 120a includes the processor 112a and the memory 112b (FIG. 1C), while omitting one or more other components of the electronics 112. In some embodiments, the NMD 120a includes additional components (e.g., one or more sensors, cameras, thermometers, barometers, hygrometers, etc.).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1C) configured to receive user input (e.g., touch input, voice input, etc.) without a separate control device. In other embodiments, however, the playback device 110r receives commands from another control device (e.g., the control device 130a of FIG. 18). Additional NMD embodiments are described in further detail below with respect to FIGS. 3A-3F.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyze the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON VAS, a user might speak the activation word “Alexa”. Other examples include “Okay Google” for invoking the GOOGLE VAS and “Hey Siri” for invoking the APPLE VAS.

After detecting the activation word, voice processing components 124 monitor the microphone data for an accompanying user request in the voice input. The user request may include, for example, a command to control a third-party device, such as a thermostat (e.g., NEST thermostat), an illumination device (e.g., a PHILIPS HUE lighting device), or a media playback device (e.g., a SONOS playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A-3F.

d. Suitable Control Devices

FIG. 1H is a partial schematic diagram of the control device 130a (FIGS. 1A and 1B). As used herein, the term “control device” can be used interchangeably with “controller” or “control system”. Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone, etc.) on which media playback system controller application software is installed. In some embodiments, the control device 130a comprises, for example, a tablet (e.g., an iPad™) a computer (e.g., a laptop computer, a desktop computer, etc.), and/or another suitable device (e.g., a television, an automobile audio head unit, an IoT device, etc.). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 132b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE, etc.). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection, etc.) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others. Additional description of zones and groups can be found below with respect to FIGS. 1I-1M.

The user interface 133 is configured to receive user input and can facilitate control of the media playback system 100. The user interface 133 includes media content art 133a (e.g., album art, lyrics, videos, etc.), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year, etc.) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone, etc.). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

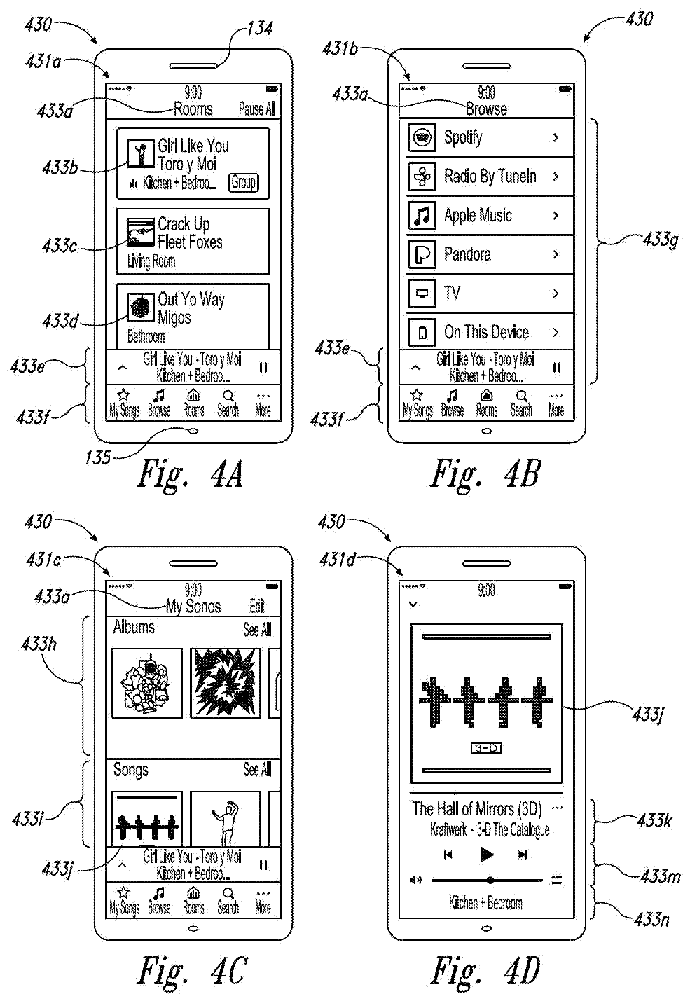

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound, etc.) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device, etc.) comprising a portion of the electronics 132 and the user interface 133 (e.g., a touch screen) without any speakers or microphones. Additional control device embodiments are described in further detail below with respect to FIGS. 4A-4D and 5.

e. Suitable Playback Device Configurations

FIGS. 1I-1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110I (e.g., a left playback device) can be bonded to the playback device 110m (e.g., a right playback device) to form Zone B. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110b and 110d can be merged to form a merged group or a zone group 108b. The merged playback devices 110b and 110d may not be specifically assigned different playback responsibilities. That is, the merged playback devices 110b and 110d may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1I, the playback devices 110l and 110m may be bonded so as to produce or enhance a stereo effect of audio content. In this example, the playback device 110l may be configured to play a left channel audio component, while the playback device 110m may be configured to play a right channel audio component. In some implementations, such stereo bonding may be referred to as “pairing”.

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured to render low frequencies. When unbonded, however, the Front device 110h can be configured to render a full range of frequencies. As another example, FIG. 1K shows the Front and SUB devices 110h and 110i further bonded with Left and Right playback devices 110j and 110k, respectively. In some implementations, the Right and Left devices 110j and 112k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n in the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in subsequently referenced U.S. Pat. No. 10,499,146.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, zone group 108b can be assigned a name such as “Dining+Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variable instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the den may indicate that the den is not grouped with other zones but includes bonded playback devices 110h-110k. Identifiers associated with the dining room may indicate that the dining room is part of the Dining+Kitchen zone group 108b and that devices 110b and 110d are grouped (FIG. 1L). Identifiers associated with the kitchen may indicate the same or similar information by virtue of the kitchen being part of the Dining+Kitchen zone group 108b. Other example zone variables and identifiers are described below.

In yet another example, the media playback system 100 may store variables or identifiers representing other associations of zones and zone groups, such as identifiers associated with areas, as shown in FIG. 1M. An area may involve a cluster of zone groups and/or zones not within a zone group. For instance, FIG. 1M shows an Upper Area 109a including Zones A-D and I, and a Lower Area 109b including Zones E-I. In one aspect, an area may be used to invoke a cluster of zone groups and/or zones that share one or more zones and/or zone groups of another cluster. In another aspect, this differs from a zone group, which does not share a zone with another zone group. Further examples of techniques for implementing areas may be found, for example, in U.S. Pat. No. 10,712,997 (filed 21 Aug. 2017; entitled “Room Association Based on Name”), and U.S. Pat. No. 8,483,853 (filed 11 Sep. 2007; entitled “Controlling and manipulating groupings in a multi-zone media system”), each of which is incorporated herein by reference in its entirety. In some embodiments, the media playback system 100 may not implement areas, in which case the system may not store variables associated with areas.

### III. Example Systems and Devices

FIG. 2A is a front isometric view of a playback device 210 configured in accordance with aspects of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a—f). The electronics 212 (e.g., the electronics 112 of FIG. 1C) are configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some embodiments, the playback device 210 includes a number of transducers different than those illustrated in FIGS. 2A-2C. For example, as described in further detail below with respect to FIGS. 3A-3C, the playback device 210 can include fewer than six transducers (e.g., one, two, three). In other embodiments, however, the playback device 210 includes more than six transducers (e.g., nine, ten). Moreover, in some embodiments, all or a portion of the transducers 214 are configured to operate as a phased array to desirably adjust (e.g., narrow or widen) a radiation pattern of the transducers 214, thereby altering a user's perception of the sound emitted from the playback device 210.

In some examples, a filter is axially aligned with the transducer 214b. The filter can be configured to desirably attenuate a predetermined range of frequencies that the transducer 214b outputs to improve sound quality and a perceived sound stage output collectively by the transducers 214. In some embodiments, however, the playback device 210 omits the filter. In other embodiments, the playback device 210 includes one or more additional filters aligned with the transducers 214b and/or at least another of the transducers 214.

FIGS. 3A and 3B are front and right isometric side views, respectively, of an NMD 320 configured in accordance with embodiments of the disclosed technology. FIG. 3C is an exploded view of the NMD 320. FIG. 3D is an enlarged view of a portion of FIG. 3B including a user interface 313 of the NMD 320. Referring first to FIGS. 3A-3C, the NMD 320 includes a housing 316 comprising an upper portion 316a, a lower portion 316b and an intermediate portion 316c (e.g., a grille). A plurality of ports, holes or apertures 316d in the upper portion 316a allow sound to pass through to one or more microphones 315 (FIG. 3C) positioned within the housing 316. The one or more microphones 315 are configured to receive sound via the apertures 316d and produce electrical signals based on the received sound. In the illustrated embodiment, a frame 316e (FIG. 3C) of the housing 316 surrounds cavities 316f and 316g configured to house, respectively, a first transducer 314a (e.g., a tweeter) and a second transducer 314b (e.g., a mid-woofer, a midrange speaker, a woofer). In other embodiments, however, the NMD 320 includes a single transducer, or more than two (e.g., two, five, six) transducers. In certain embodiments, the NMD 320 omits the transducers 314a and 314b altogether.

Electronics 312 (FIG. 3C) includes components configured to drive the transducers 314a and 314b, and further configured to analyze audio data corresponding to the electrical signals produced by the one or more microphones 315. In some embodiments, for example, the electronics 312 comprises many or all of the components of the electronics 112 described above with respect to FIG. 1C. In certain embodiments, the electronics 312 includes components described above with respect to FIG. 1F such as, for example, the one or more processors 112a, the memory 112b, the software components 112c, the network interface 112d, etc. In some embodiments, the electronics 312 includes additional suitable components (e.g., proximity or other sensors).

Referring to FIG. 3D, the user interface 313 includes a plurality of control surfaces (e.g., buttons, knobs, capacitive surfaces) including a first control surface 313a (e.g., a previous control), a second control surface 313b (e.g., a next control), and a third control surface 313c (e.g., a play and/or pause control) that can be adjusted by a user 323. A fourth control surface 313d is configured to receive touch input corresponding to activation and deactivation of the one or microphones 315. A first indicator 313e (e.g., one or more light emitting diodes (LEDs) or another suitable illuminator) can be configured to illuminate only when the one or more microphones 315 are activated. A second indicator 313f (e.g., one or more LEDs) can be configured to remain solid during normal operation and to blink or otherwise change from solid to indicate a detection of voice activity. In some embodiments, the user interface 313 includes additional or fewer control surfaces and illuminators. In one embodiment, for example, the user interface 313 includes the first indicator 313e, omitting the second indicator 313f. Moreover, in certain embodiments, the NMD 320 comprises a playback device and a control device, and the user interface 313 comprises the user interface of the control device.

Referring to FIGS. 3A-3D together, the NMD 320 is configured to receive voice commands from one or more adjacent users via the one or more microphones 315. As described above with respect to FIG. 1B, the one or more microphones 315 can acquire, capture, or record sound in a vicinity (e.g., a region within 10 m or less of the NMD 320) and transmit electrical signals corresponding to the recorded sound to the electronics 312. The electronics 312 can process the electrical signals and can analyze the resulting audio data to determine a presence of one or more voice commands (e.g., one or more activation words). In some embodiments, for example, after detection of one or more suitable voice commands, the NMD 320 is configured to transmit a portion of the recorded audio data to another device and/or a remote server (e.g., one or more of the computing devices 106 of FIG. 1B) for further analysis. The remote server can analyze the audio data, determine an appropriate action based on the voice command, and transmit a message to the NMD 320 to perform the appropriate action. For instance, a user may speak “Sonos, play Michael Jackson”. The NMD 320 can, via the one or more microphones 315, record the user's voice utterance, determine the presence of a voice command, and transmit the audio data having the voice command to a remote server (e.g., one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (e.g., play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (e.g., the network 104 of FIG. 1B), a remote server (e.g., one or more of the remote computing devices 106 of FIG. 1B), etc. In certain embodiments, however, the NMD 320 determines and/or performs one or more actions corresponding to the one or more voice commands without intervention or involvement of an external device, computer, or server.

FIG. 3E is a functional block diagram showing additional features of the NMD 320 in accordance with aspects of the disclosure. The NMD 320 includes components configured to facilitate voice command capture including voice activity detector component(s) 312k, beam former components 312l, acoustic echo cancellation (AEC) and/or self-sound suppression components 312m, activation word detector components 312n, and voice/speech conversion components 312o (e.g., voice-to-text and text-to-voice). In the illustrated embodiment of FIG. 3E, the foregoing components 312k-312o are shown as separate components. In some embodiments, however, one or more of the components 312k-312o are subcomponents of the processors 112a.

The beamforming and self-sound suppression components 312l and 312m are configured to detect an audio signal and determine aspects of voice input represented in the detected audio signal, such as the direction, amplitude, frequency spectrum, etc. The voice activity detector activity components 312k are operably coupled with the beamforming and AEC components 312l and 312m and are configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is measure of spectral structure. As those of ordinary skill in the art will appreciate, speech typically has a lower entropy than most common background noise.

The activation word detector components 312n are configured to monitor and analyze received audio to determine if any activation words (e.g., wake words) are present in the received audio. The activation word detector components 312n may analyze the received audio using an activation word detection algorithm. If the activation word detector 312n detects an activation word, the NMD 320 may process voice input contained in the received audio. Example activation word detection algorithms accept audio as input and provide an indication of whether an activation word is present in the audio. Many first- and third-party activation word detection algorithms are known and commercially available. For instance, operators of a voice service may make their algorithm available for use in third-party devices. Alternatively, an algorithm may be trained to detect certain activation words. In some embodiments, the activation word detector 312n runs multiple activation word detection algorithms on the received audio simultaneously (or substantially simultaneously). As noted above, different voice services (e.g., AMAZON's ALEXA, APPLE's SIRI, or MICROSOFT's CORTANA) can each use a different activation word for invoking their respective voice service. To support multiple services, the activation word detector 312n may run the received audio through the activation word detection algorithm for each supported voice service in parallel.

The speech/text conversion components 312o may facilitate processing by converting speech in the voice input to text. In some embodiments, the electronics 312 can include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional voice activity services, which typically sample from a broad base of users and diverse requests that are not targeted to media playback systems.

FIG. 3F is a schematic diagram of an example voice input 328 captured by the NMD 320 in accordance with aspects of the disclosure. The voice input 328 can include an activation word portion 328a and a voice utterance portion 328b. In some embodiments, the activation word 328a can be a known activation word, such as “Alexa”, which is associated with AMAZON's ALEXA. In other embodiments, however, the voice input 328 may not include an activation word. In some embodiments, a network microphone device may output an audible and/or visible response upon detection of the activation word portion 328a. Additionally or alternately, an NMD may output an audible and/or visible response after processing a voice input and/or a series of voice inputs.

The voice utterance portion 328b may include, for example, one or more spoken commands (identified individually as a first command 328c and a second command 328e) and one or more spoken keywords (identified individually as a first keyword 328d and a second keyword 328f). In one example, the first command 328c can be a command to play music, such as a specific song, album, playlist, etc. In this example, the keywords may be one or words identifying one or more zones in which the music is to be played, such as the living room and the dining room shown in FIG. 1A. In some examples, the voice utterance portion 328b can include other information, such as detected pauses (e.g., periods of non-speech) between words spoken by a user, as shown in FIG. 3F. The pauses may demarcate the locations of separate commands, keywords, or other information spoke by the user within the voice utterance portion 328b.

In some embodiments, the media playback system 100 is configured to temporarily reduce the volume of audio content that it is playing while detecting the activation word portion 328a. The media playback system 100 may restore the volume after processing the voice input 328, as shown in FIG. 3F. Such a process can be referred to as ducking, examples of which are disclosed in U.S. Pat. No. 10,499,146 (filed 21 Feb. 2017; entitled “Voice control of a media playback system”), which is incorporated herein by reference in its entirety.

FIGS. 4A-4D are schematic diagrams of a control device 430 (e.g., the control device 130a of FIG. 1H, a smartphone, a tablet, a dedicated control device, an IoT device, and/or another suitable device) showing corresponding user interface displays in various states of operation. A first user interface display 431a (FIG. 4A) includes a display name 433a (i.e., “Rooms”). A selected group region 433b displays audio content information (e.g., artist name, track name, album art) of audio content played back in the selected group and/or zone. Group regions 433c and 433d display corresponding group and/or zone name, and audio content information audio content played back or next in a playback queue of the respective group or zone. An audio content region 433e includes information related to audio content in the selected group and/or zone (i.e., the group and/or zone indicated in the selected group region 433b). A lower display region 433f is configured to receive touch input to display one or more other user interface displays. For example, if a user selects “Browse” in the lower display region 433f, the control device 430 can be configured to output a second user interface display 431b (FIG. 4B) comprising a plurality of music services 433g (e.g., Spotify, Radio by Tunein, Apple Music, Pandora, Amazon, TV, local music, line-in) through which the user can browse and from which the user can select media content for play back via one or more playback devices (e.g., one of the playback devices 110 of FIG. 1A). Alternatively, if the user selects “My Sonos” in the lower display region 433f, the control device 430 can be configured to output a third user interface display 431c (FIG. 4C). A first media content region 433h can include graphical representations (e.g., album art) corresponding to individual albums, stations, or playlists. A second media content region 433i can include graphical representations (e.g., album art) corresponding to individual songs, tracks, or other media content. If the user selects a graphical representation 433j (FIG. 4C), the control device 430 can be configured to begin play back of audio content corresponding to the graphical representation 433j and output a fourth user interface display 431d that includes an enlarged version of the graphical representation 433j, media content information 433k (e.g., track name, artist, album), transport controls 433m (e.g., play, previous, next, pause, volume), and indication 433n of the currently selected group and/or zone name.

FIG. 5 is a schematic diagram of a control device 530 (e.g., a laptop computer, a desktop computer). The control device 530 includes transducers 534, a microphone 535, and a camera 536. A user interface 531 includes a transport control region 533a, a playback status region 533c, a playback zone region 533b, a playback queue region 533d, and a media content source region 533e. The transport control region comprises one or more controls for controlling media playback including, for example, volume, previous, play/pause, next, repeat, shuffle, track position, crossfade, equalization, etc. The audio content source region 533e includes a listing of one or more media content sources from which a user can select media items for play back and/or adding to a playback queue.

The playback zone region 533b can include representations of playback zones within the media playback system 100 (FIGS. 1A and 18). In some embodiments, the graphical representations of playback zones may be selectable to bring up additional selectable icons to manage or configure the playback zones in the media playback system, such as a creation of bonded zones, creation of zone groups, separation of zone groups, renaming of zone groups, etc. In the illustrated embodiment, a “group” icon is provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone can be configured to play audio content in synchrony with the playback device(s) in the particular zone. Analogously, a “group” icon may be provided within a graphical representation of a zone group. In the illustrated embodiment, the “group” icon may be selectable to bring up options to deselect one or more zones in the zone group to be removed from the zone group. In some embodiments, the control device 530 includes other interactions and implementations for grouping and ungrouping zones via the user interface 531. In certain embodiments, the representations of playback zones in the playback zone region 533b can be dynamically updated as playback zone or zone group configurations are modified.

The playback status region 533c includes graphical representations of audio content that is presently being played, previously played, or scheduled to play next in the selected playback zone or zone group. The selected playback zone or zone group may be visually distinguished on the user interface, such as within the playback zone region 533b and/or the playback queue region 533d. The graphical representations may include track title, artist name, album name, album year, track length, and other relevant information that may be useful for the user to know when controlling the media playback system 100 via the user interface 531.

The playback queue region 533d includes graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device. In some embodiments, for example, a playlist can be added to a playback queue, in which information corresponding to each audio item in the playlist may be added to the playback queue. In some embodiments, audio items in a playback queue may be saved as a playlist. In certain embodiments, a playback queue may be empty, or populated but “not in use” when the playback zone or zone group is playing continuously streaming audio content, such as Internet radio that may continue to play until otherwise stopped, rather than discrete audio items that have playback durations. In some embodiments, a playback queue can include Internet radio and/or other streaming audio content items and be “in use” when the playback zone or zone group is playing those items.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped.

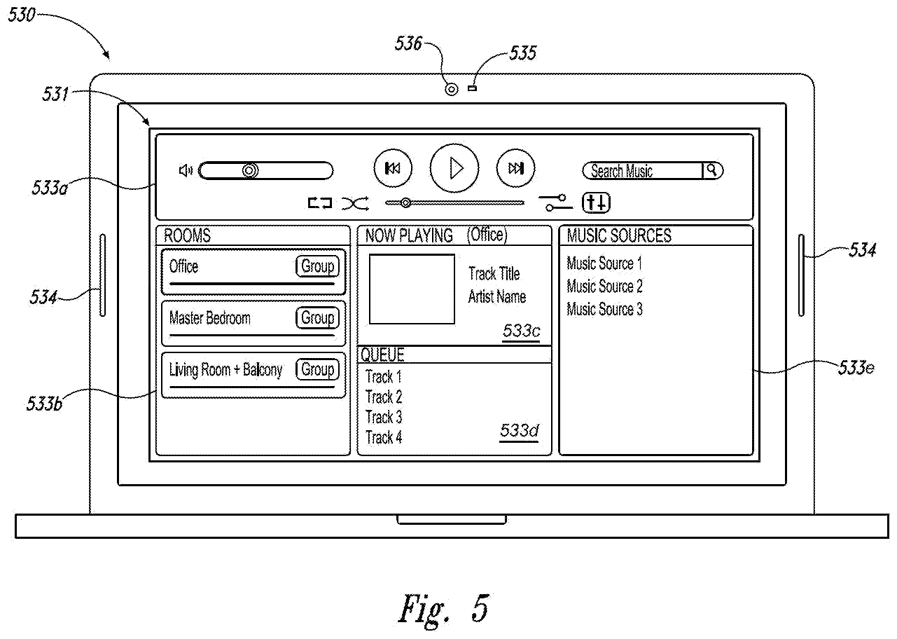

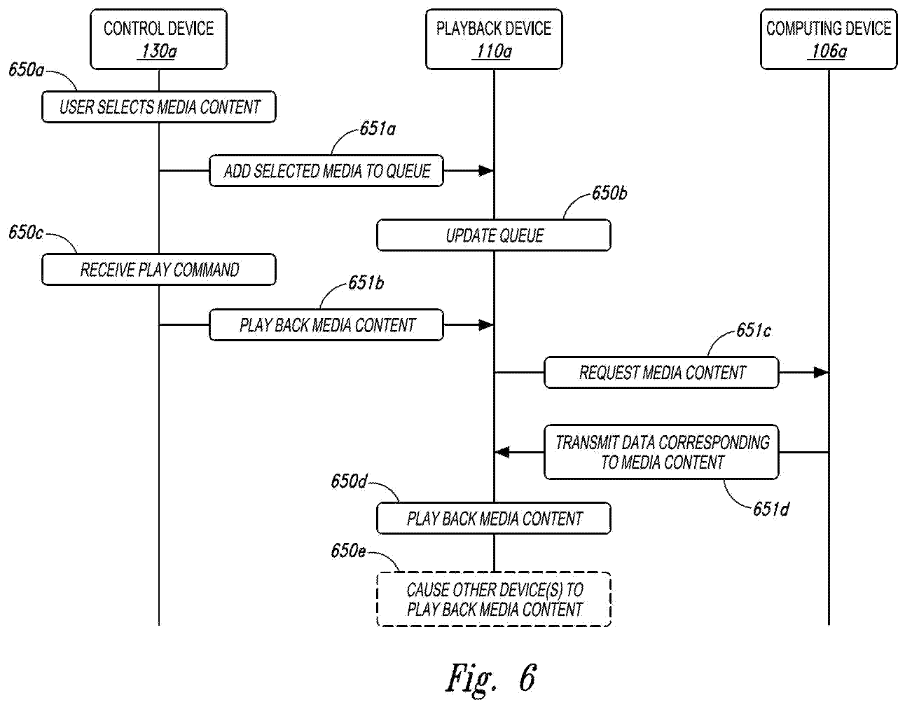

FIG. 6 is a message flow diagram illustrating data exchanges between devices of the media playback system 100 (FIGS. 1A-1M).

At step 650a, the media playback system 100 receives an indication of selected media content (e.g., one or more songs, albums, playlists, podcasts, videos, stations) via the control device 130a. The selected media content can comprise, for example, media items stored locally on one or more devices (e.g., the audio source 105 of FIG. 1C) connected to the media playback system and/or media items stored on one or more media service servers (one or more of the remote computing devices 106 of FIG. 18). In response to receiving the indication of the selected media content, the control device 130a transmits a message 651a to the playback device 110a (FIGS. 1A-1C) to add the selected media content to a playback queue on the playback device 110a.

At step 650b, the playback device 110a receives the message 651a and adds the selected media content to the playback queue for play back.

At step 650c, the control device 130a receives input corresponding to a command to play back the selected media content. In response to receiving the input corresponding to the command to play back the selected media content, the control device 130a transmits a message 651b to the playback device 110a causing the playback device 110a to play back the selected media content. In response to receiving the message 651b, the playback device 110a transmits a message 651c to the computing device 106a requesting the selected media content. The computing device 106a, in response to receiving the message 651c, transmits a message 651d comprising data (e.g., audio data, video data, a URL, a URI) corresponding to the requested media content.

At step 650d, the playback device 110a receives the message 651d with the data corresponding to the requested media content and plays back the associated media content.

At step 650e, the playback device 110a optionally causes one or more other devices to play back the selected media content. In one example, the playback device 110a is one of a bonded zone of two or more players (FIG. 1M). The playback device 110a can receive the selected media content and transmit all or a portion of the media content to other devices in the bonded zone. In another example, the playback device 110a is a coordinator of a group and is configured to transmit and receive timing information from one or more other devices in the group. The other one or more devices in the group can receive the selected media content from the computing device 106a, and begin playback of the selected media content in response to a message from the playback device 110a such that all of the devices in the group play back the selected media content in synchrony.

### IV. Off-Net Synchrony Groups

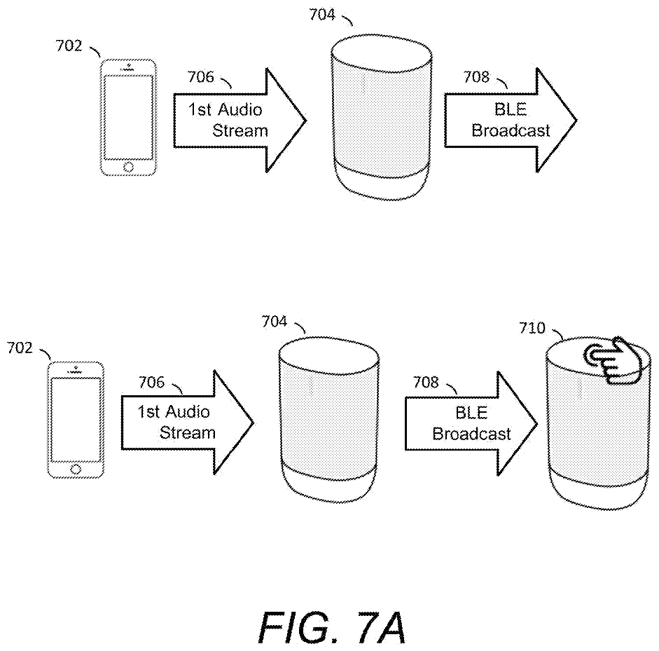

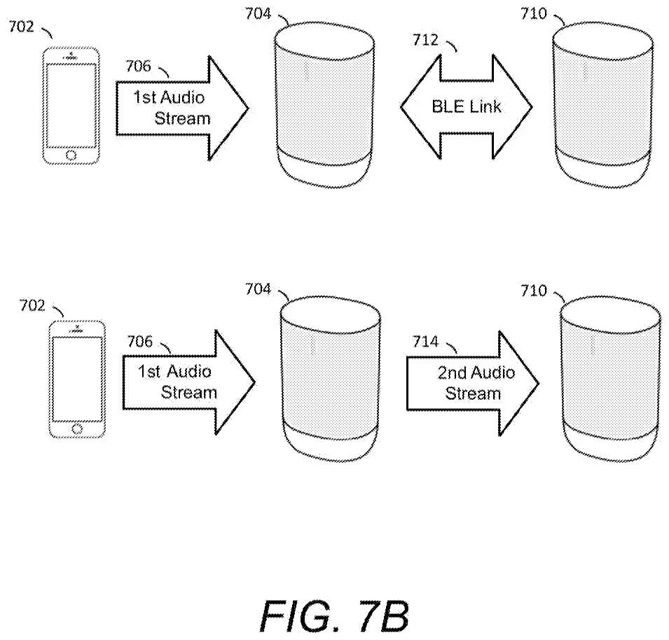

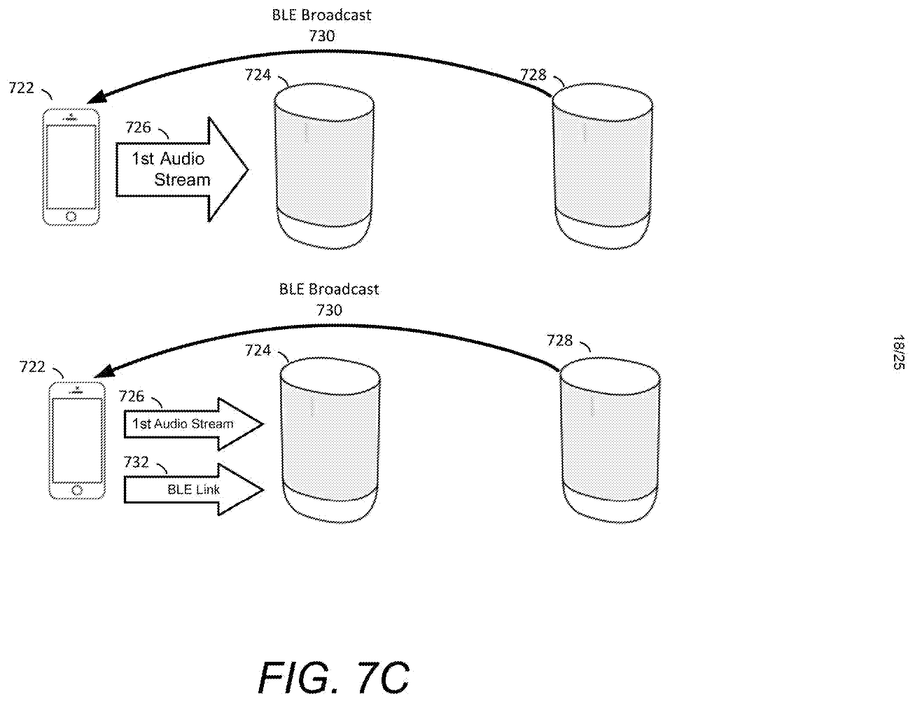

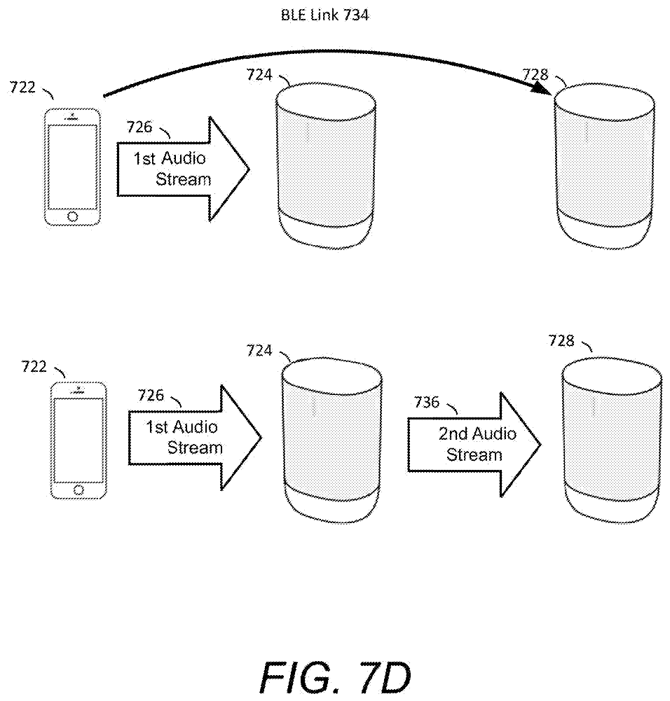

As described hereinabove, in an off-net environment, a primary playback device can be configured to operate as a soft AP to create a wireless network for streaming of audio content between multiple additional playback devices. Examples of one or more off-net environments are provided in PCT Publication WO 2023/055742 A1 (filed 27 Sep. 2022; entitled “Synchronous playback of media content by off-net portable playback devices”), which is incorporated herein by reference in its entirety. FIGS. 7A and 7B illustrate a sample overview of a device and process flow as multiple playback devices form a synchrony group for simultaneous playback of audio content. As shown in the top portion of FIG. 7A, an external device such as smartphone 702 can be operatively connected to a primary playback device 704 via, for example, a first wireless network including a BLUETOOTH Classic stream. The smartphone 702 can be configured to provide a first audio stream 706 to the primary playback device via the first wireless connection. In response to receiving the first audio stream 706, the primary playback device 704 can be configured to play back the stream and to broadcast an indication of the availability of the audio stream. For example, the primary playback device 704 can be configured to output one or more BLE broadcasts 708 providing an indication of the availability of the first audio stream 706 to one or more additional playback devices.

As shown in the bottom portion of FIG. 7A, after a period of time, a second playback device 710 can move within range of the primary playback device 704. For example, depending upon the strength of the BLE broadcast(s) 708, the range of primary playback device 704 can be approximately 10 feet, 15 feet, 25 feet, 30 feet, 35 feet, 40 feet, 45 feet, or 50 feet. Once the second playback device 710 has moved within range of the primary playback device 704, the second playback device can detect a press-and-hold of the play/pause button by the user of the second playback device, providing an indication that the second playback device is to search for one or more available audio streams. For example, based upon the detected press-and-hold of the play/pause button, the second playback device 710 can detect one or more of the BLE broadcast(s) 708 as transmitted by the primary playback device 704.

As shown in the top portion of FIG. 7B, the primary playback device 704 and the second playback device 710 can establish a BLE link 712. The primary playback device 704 can receive information from the second playback device 710 via the BLE link 712 such as, for example, a request to establish a new wireless network. The new wireless network may be, for example, a WIFI network, a BLUETOOTH network, a Z-Wave network, or a ZIGBEE network. In response to such a request, the primary playback device 704 can establish the new wireless network and provide information such as authentication and credential information to the second playback device 710 via the BLE link 712. The second playback device 710 can use the information as received via the BLE link 712 to join the newly created wireless network and operably connect via the wireless network to the primary playback device 704.

As shown in the bottom portion of FIG. 7B, once the second playback device 710 has connected to the primary playback device 704 via the newly created wireless network, the primary playback device 704 can transmit a second audio stream 714 directly to the second playback device 710 over the newly created wireless network. In such an example, the primary playback device 704 can facilitate synchronous playback of the audio stream with the second playback device 710 in an off-net environment where, prior to the primary playback device 704 forming the second wireless network, no existing wireless networks were available for streaming of the audio content between the playback devices. Additionally, in such an example, the primary playback device 704 can be configured to conserve power as it is only operating as a soft AP when another playback device (e.g., second playback device 710) is within range and configured to receive the audio stream. As such, when no additional playback devices are operably connected to the primary playback device 704 via the second wireless network, the primary playback device 704 can be configured to turn off any network interface functionality associated with the soft AP, thereby turning off the second wireless network, and conserving power until another request for audio streaming is received from another playback device.

FIGS. 7C and 7D illustrate an alternative sample overview of a device and process flow as multiple playback devices form a synchrony group for simultaneous playback of audio content. In this example, rather than the user pushing-and-holding the play/pause button on the second playback device, the user can instead use the controller directly (e.g., without touching the playback devices).

As shown in the top portion of FIG. 7C, an external controller device such as smartphone 722 can be operatively connected to a primary playback device 724 via, for example, a first wireless network including a BLUETOOTH Classic stream. The smartphone 722 can be configured to provide a first audio stream 726 to the primary playback device via the first wireless connection. In response to receiving the first audio stream 726, the primary playback device 724 can be configured to play back the stream. Additionally, as further shown in the top portion of FIG. 7C, a new playback device 728 can be moved within range of the smartphone 722 and can broadcast a BLE message indicating its presence. The smartphone 722 can be configured to receive the BLE broadcast 730 and process accordingly including, for example, displaying the presence of the second playback device. In turn, the smartphone 722 may detect input from the user to group the first playback device 724 with the second playback device 728. For instance, the smartphone 722 may detect activation of a grouping button and selection of the first and second playback devices 724 and 728 to be grouped for synchronous playback.

As shown in the bottom portion of FIG. 7C, the smartphone 722 can establish a BLE link 732 with the primary playback device 724 (in addition to the classic BLUETOOTH connection that is providing the first audio stream 726). The smartphone 722 can provide information to the playback device 724 to establish a wireless network (e.g., a WIFI network, a BLUETOOTH network, a Z-Wave network, or a ZIGBEE network). The primary playback device 724 may create the wireless network by, for example, enabling soft AP functionality such that it is functioning as a wireless network access point as described herein. The primary playback device 724 may provide information to the smartphone 722 including connection information related to the wireless network.

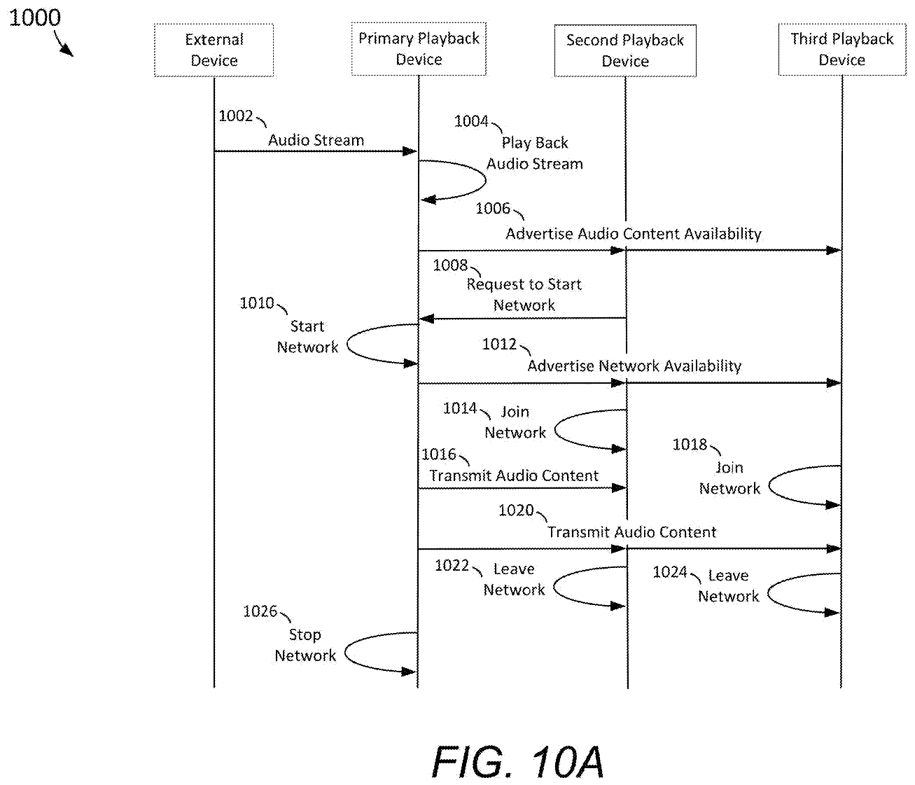

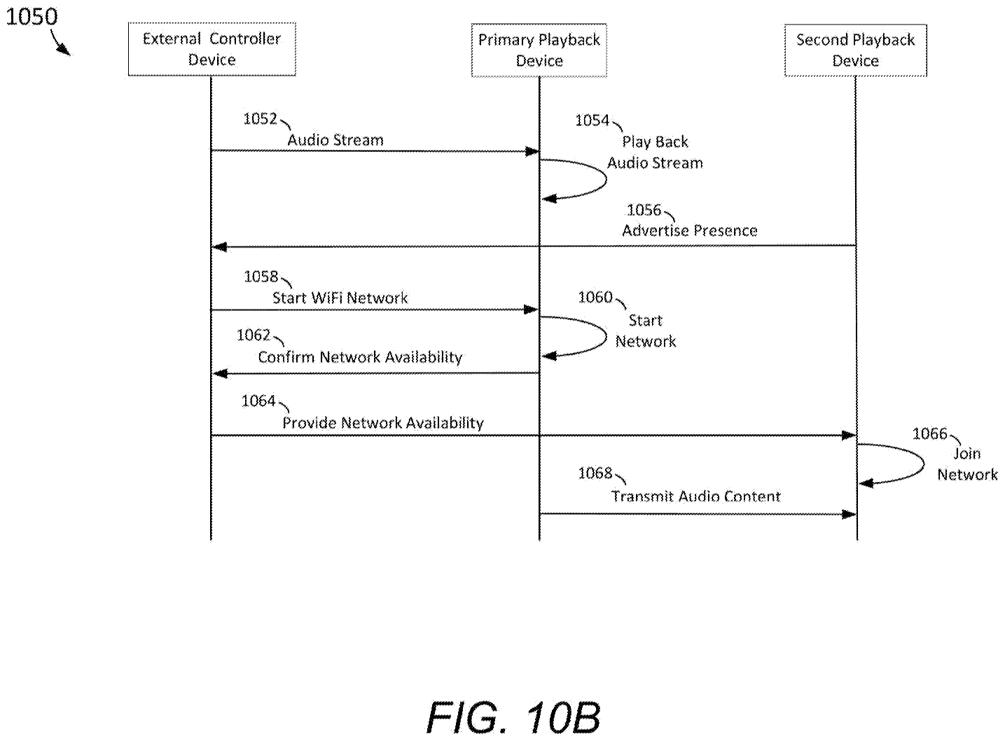

As shown in the top portion of FIG. 7D, the smartphone 722 can establish a BLE link 734 with the new playback device 728 to transmit a request to join the network created by the primary playback device 724 (e.g., and any other information such as wireless network details). As shown in the bottom portion of FIG. 7D, the new playback device 728 can operably connect to the wireless network and receive a second audio stream 736 from the primary playback device 724 via the wireless network. Additional detail related to the process flow as described above in regard to FIGS. 7C and 7D can be found in the discussion of FIG. 10B below.

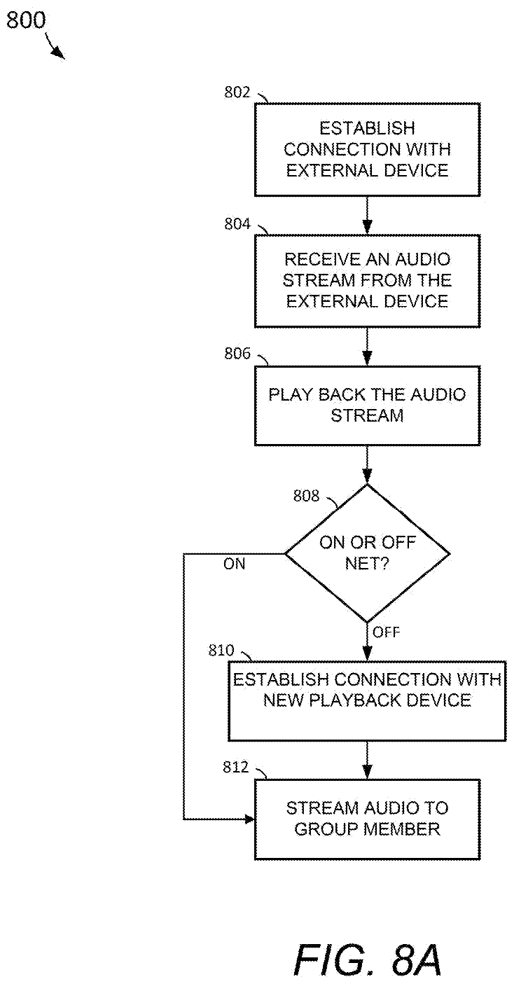

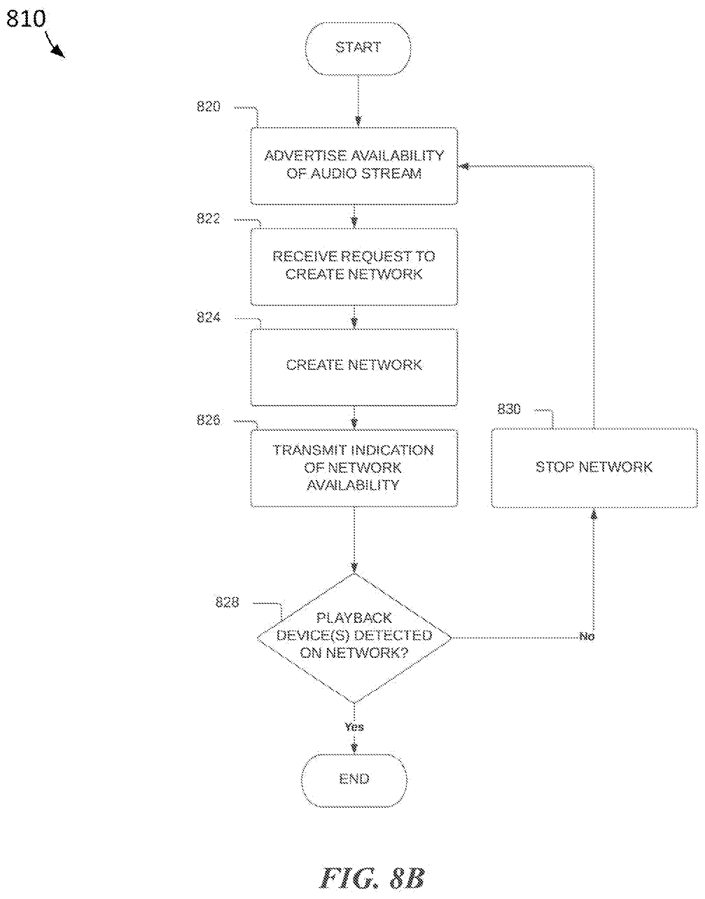

FIG. 8A illustrates an example process performed by a primary playback device in providing an audio stream to a secondary playback device. FIG. 8B illustrates a more specific example process flow of additional process steps used to establish a connection between the playback devices. The processes as shown in FIGS. 8A and 8B can be performed by, for example, primary playback device 704 and/or 724, as described above.

As shown in FIG. 8A, the process 800 can begin when the primary playback device establishes 802 a connection with an external device. As described herein, the external device can include a smartphone such as smartphone 702 as described above. The established connection can include, for example, a BLUETOOTH Classic connection established between the external device and the primary playback device using standard BLUETOOTH connection parameters. Once the connection has been established, the primary playback device can receive 804 an audio stream from the external device and perform any necessary processing on the received audio stream. For example, the primary playback device (e.g., using one or more processors, audio processing components, and/or audio amplifier(s)) may process the received audio stream. After processing, the primary playback device can playback 806 the audio stream via, for example, one or more speakers (e.g., integrated into the playback device).

To establish a synchrony group, as further shown in FIG. 8A, the primary playback device can determine 808 whether the primary playback device is operating in an on-net situation (e.g., at a home, office, etc.) or an off-net situation (e.g., at a park, beach, or on a hike). If the primary playback device does determine 808 that the primary playback device is currently in an on-net situation, the primary playback device can establish a synchrony group including the additional playback device as a new group member and stream 812 the audio to the new group member over the established network. Conversely, if the primary playback device determines 808 that the primary playback device is operating in an off-net situation, the primary playback device can establish 810 a connection with another playback device and stream 812 the audio to the other playback device via the newly established connection.

FIG. 8B illustrates a more detailed process of step 810 as shown in FIG. 8A for establishing a connection between the primary playback device and another playback device for synchronous playback of audio content. As shown in FIG. 8B, the primary playback device can advertise an availability of the audio stream 820. As described above, this advertisement may comprise one or more broadcast messages (e.g., BLE broadcasts) indicating the availability of the audio stream as received from the external device. Additionally, in some examples, the advertisements can further include timestamp information such that any playback device receiving the advertisements can synchronize with the primary playback device. During the advertisement of the availability of the audio stream 820, the primary playback device can receive 822 a request to create or otherwise establish a network (e.g., that another playback can connect to). For example, the primary playback device may receive the request from an additional playback device (e.g., a secondary playback device). In other examples, the primary playback device may receive the request from a control device (e.g., a smartphone executing a controller application). For instance, the control device may have detected user input indicative of a request for a secondary playback device to play back the available audio stream. In this instance, the control device may request that the primary playback device create a network that the secondary playback device can connect to and obtain the audio stream.

As further shown in FIG. 8B, the primary playback device can create 824 the network. For instance, the primary playback device may begin to function as a soft AP hosting, for example, a wireless network. In some examples, the newly created network can be implemented as a 802.11-based wireless network. In some implementations, the newly created network can be a 2.4 GHz WIFI network, a 5.0 GHz WIFI network, and other similar wireless networks as defined by or associated with the 802.11 protocol.

Upon creation 824 of the network, the primary playback device can notify 826 the additional playback device of the network. For instance, the primary playback device may advertise availability of the network for other playback devices to join (e.g., to obtain access to the available audio stream). The primary playback device may monitor activity on the created network to determine whether additional playback devices have been detected 828 on the network. If additional playback devices have been detected on the network, the primary playback device continues to (as shown in FIG. 8A) stream audio 812 to the detected player. Conversely, if no additional playback devices have been detected on the network (e.g., no devices have connected to the network) for a period of time (e.g., 2 minutes, 5 minutes, 10 minutes, 15 minutes, 30 minutes, etc.), the primary playback device may proceed to stop 830 the network to conserve power and return to advertise 820 availability of the audio stream.

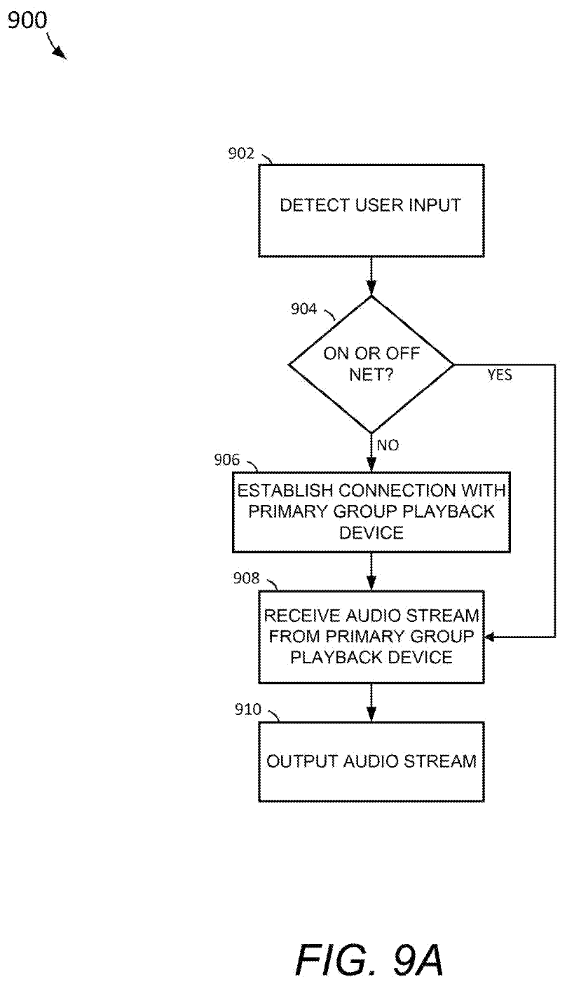

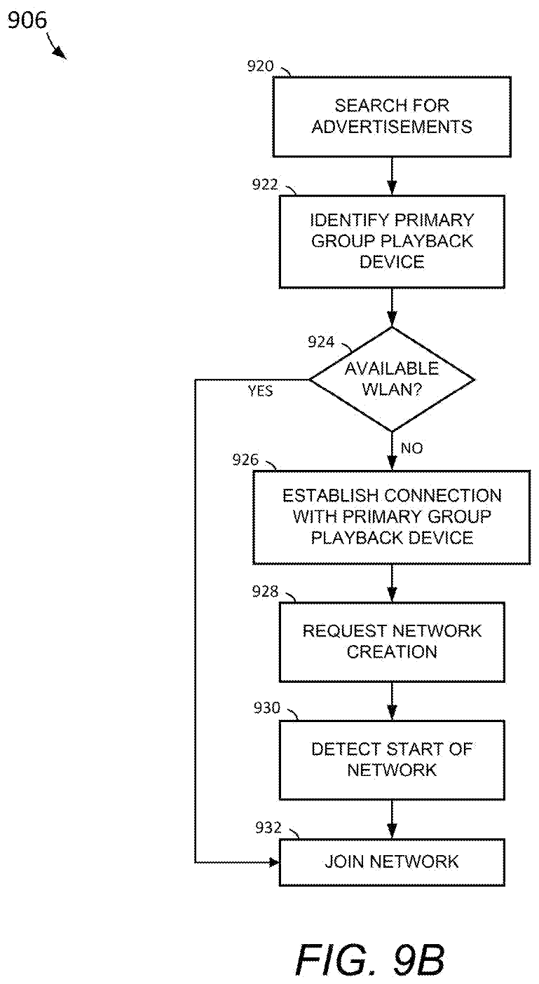

FIG. 9A illustrates an example process performed by a secondary playback device in obtaining an audio stream from a primary playback device as described herein. FIG. 9B illustrates a more specific example process flow including additional process steps used to request creation of a new wireless network by a second playback device as well as the steps used by the second playback device to join the newly created wireless network. The processes as shown in FIGS. 9A and 9B can be performed by, for example, secondary playback device 710 and/or 728, as described above.

As shown in FIG. 9A, the process 900 can begin when the secondary playback device detects 902 user input indicative of a request to playback an audio stream being played back by another player (e.g., a primary playback device). For example, the detected user input may be a detected press-and-hold action by a user on a button (e.g., a play/pause button) on the secondary playback device. It should be appreciated that the detected user input may take other forms (e.g., a voice command) or may be detected using another device that relays the request (or any derivative thereof) to the secondary playback device (e.g., detection of user input on a control device that is forwarded to the secondary playback device).

As further shown in FIG. 9A, the secondary playback device can further determine 904 whether the secondary playback device is operating in an on-net scenario or an off-net scenario as described herein. If the secondary playback device determines 904 that the secondary playback device is operating in an on-net scenario, the secondary playback device can receive 908 the audio stream from the primary playback device in the synchrony group via the established network. Conversely, if the secondary playback device determines 904 that the secondary playback device is operating in an off-net scenario, the secondary playback device can establish 906 a connection with the primary playback device as described herein. Upon establishing 906 the connection, the secondary playback device can receive 908 the audio stream from the primary playback device via the established connection and output 910 the audio stream using, for example, one or more speakers integrated within the secondary playback device.

FIG. 9B illustrates a more detailed view of step 906 as shown in FIG. 9A for establishing connection with the primary playback device (e.g., in a synchrony group). For example, as shown in FIG. 9B, step 906 can further include the secondary playback device searching 920 for advertisements transmitted by, for example, the primary playback device. For example, as described above, these advertisements may be broadcast availability messages such as one or more BLE broadcasts that include an indication of the availability of an audio stream. In response to the search, the secondary playback device can identify 922 a primary playback device associated with the advertisements.

As further shown in FIG. 9B, the secondary playback device can further determine 924 if there is an available local network associated with the primary playback device. For example, the secondary playback device can determine 924 whether the primary playback device is already functioning as a soft AP or otherwise hosting a local wireless network. If the secondary playback device does determine 924 that the primary playback device is functioning as a soft AP, the secondary playback device can immediately join 932 the network such that the secondary playback device can receive the audio content from the primary playback device. Conversely, if the secondary playback device determines 924 that there is no available local wireless network being hosted by the primary playback device, the secondary playback device can establish 926 a connection (e.g., a BLE connection) with the primary group playback device.

Additionally, as further shown in FIG. 9B, the secondary playback device can request 928 that the primary playback device create a wireless network for the streaming of the audio content to the playback device. After transmitting the request, the secondary playback device can detect 930 the start of the wireless network by the primary playback device. In response to detecting 930 the start of the network, the secondary playback device can join 932 the wireless network as hosted by the primary playback device. Referring back to FIG. 9A, the secondary playback device can now receive 908 the audio stream from the primary playback device and output 910 the audio stream via, for example, one or more speakers integrated within the secondary playback device.

It should be noted that processes 800 and 900 as shown in FIGS. 8A and 9A, and the more specific process steps as shown in FIGS. 8B and 9B, are provided by way of example only. In certain implementations of the systems and methods as described herein, the process steps as shown in these example processes can be altered accordingly. For example, the individual order of steps as shown in the processes can be altered depending upon the implementation of the systems and methods as described. Similarly, one or more steps can be combined into a single process step depending upon the implementation of the systems and methods described herein.

FIG. 10A illustrates a sample sequence diagram 1000 illustrating the interaction between a primary playback device receiving an audio stream from an external device (e.g., a smartphone, a tablet, etc.) and multiple additional playback devices. As described herein, the additional playback devices can be operably coupled to the primary playback device via, for example, a wireless network established and hosted by the primary playback device.

For example, as shown in sequence diagram 1000, the sequence can begin when the external device transmits an audio stream 1002 to the primary playback device. The primary playback device can receive the audio stream, process the audio stream, and playback 1004 the audio stream via, for example, one or more speakers integrated within the primary playback device. Additionally, as described herein, the primary playback device can advertise 1006 audio content availability to one or more playback devices within range of the primary playback device. For example, this advertisement may include a BLE message (e.g., a BLE broadcast) indicating availability of the audio stream. In this example, a second playback device and a third playback device are within range of the primary playback device. As such, both the second playback device and the third playback device receive the advertisements indicating the audio content availability.

As further shown in the sequence diagram 1000, at least one of the second playback device and/or the third playback device can transmit a request 1008 to the primary playback device to start a network for streaming the audio content. It should be noted that the second playback device is shown as transmitting the request to start the network by way of example only. In certain implementations, the request to start the network can be received by the primary playback device from the third playback device (or any other playback device within range of the primary playback device and responding to the broadcast message of audio content availability).

In response to the request to start the network, the primary playback device can process the request and start 1010 the newly created wireless network. As described herein, the newly created wireless network can include an 802.11-based wireless network, such as a 2.4 GHz WIFI network, a 5 GHz WIFI network, and/or a 6 GHz WIFI network. After the network is created, the primary playback device can advertise 1012 the availability of the newly created wireless network to the second playback device, the third playback device, and any other playback devices currently within range of the primary playback device. Such an advertisement of the network availability can be, for example, a BLE message (e.g., a BLE broadcast).

As further shown in FIG. 10A, the second playback device can join 1014 the network. Upon detecting that the second playback device has joined the network, the primary playback device can transmit 1016 the audio content to the second playback device using, for example, the newly created wireless network, and the second playback device can, for example, play back the audio content in synchrony with the primary playback device. In certain implementations, at a later time, the third playback device can also join 1018 the wireless network. In response to detecting that the third playback device has joined the network, the primary playback device can transmit 1020 the audio content to the third playback device using the newly created wireless network, and the third playback device can, for example, play back the audio content in synchrony with the primary playback device and the second playback device.

At some point, as further shown in FIG. 10A, the second playback device can leave 1022 the wireless network. Similarly, the third playback device can also leave 1024 the wireless network. Upon detecting that both the second playback device and the third playback device have left the network, the primary playback device can turn off any network interface functionality associated with hosting the wireless network, thereby stopping 1026 the network and conserving power at the primary playback device.

It should be noted that the primary playback device turning off the network in response to detecting that both the second playback device and third playback devices shown in sequence diagram 1000 is provided by way of example only. In certain implementations, the primary playback device can be configured to turn off the network in response to, for example, user input such as a press-and-hold of the input button such as a play/pause button as described herein.

It should also be noted that the example sequence diagram as shown in FIG. 10A is provided by way of example only. In actual implementation, the order of various sequence steps can be altered, one or more sequence steps can be combined, and other similar changes can be included.

FIG. 10B is a sample sequence diagram 1050 illustrating the interaction between an external controller device, a primary playback device, and a second playback device as described, for example, in the above discussion of FIGS. 7C and 7D. As described herein, connections between the playback devices can be controlled by a user of the external controller device.

For example, as shown in sequence diagram 1050, the external controller device can be configured to provide an audio stream 1052 to the primary playback device. The primary playback device can be configured to play back 1054 the audio stream. At some point, the external controller can detect the presence of a second playback device. For example, the second playback device can advertise 1056 its presence using, for example, a BLE broadcast as described herein. The external controller device can receive and process the advertisement from the second playback device. This processing can include parsing of the content of the advertisement including, for example, one or more of: (1) extracting a device name, type, or other identifier from the BLE broadcast; (2) extracting status information regarding the device from the BLE broadcast; and/or (3) providing a control for the second playback device within a user interface of the external controller device. The user may select the user interface control element (e.g., associated with grouping of playback devices for synchronous playback) to request that the second playback device be added to the synchrony group.

In response to selection of the user interface control, the external controller device can provide (e.g., via one or more BLE messages, as described in PCT Publication WO 2023/039294 A2 (filed 13 Sep. 2022; entitled “Techniques for flexible control of playback devices”), which is incorporated herein by reference in its entirety) instructions to the primary playback device. These instructions can include instructions to start 1058 a wireless network, such as a WIFI network as described herein. In response, the primary playback device can start 1060 the wireless network and confirm 1062 the network availability to the external controller device. The external controller device can provide 1064 (e.g., via a BLE message, which may or may not involve tearing down of a BLE connection with the primary device) information related to the network availability to the second playback device. Using the information related to the network availability, the second playback device can join 1066 the wireless network. Once the second playback device has joined the wireless network, the primary playback device can broadcast 1068 the audio content to the second playback device for output, and the second playback device can play back the audio content in synchrony with the primary playback device.

It should be noted that the example sequence is shown in FIG. 10B is provided by way of example only. In actual implementation, the order of various sequence steps can be altered, one or more sequence steps can be combined, and other similar changes can be included. For instance, in examples where the external controller device cannot maintain concurrent BLE connections with the primary playback device and the second playback device, the external controller device can tear down the BLE connection with the second playback device prior to reestablishing a BLE connection with the primary playback device (e.g., subsequent to providing 1064 the information related to the network availability to the second playback device).

### V. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods. For example, when providing for network creation and simultaneous audio play back between multiple playback devices in off-net environments, it should be appreciated that each of the playback devices can be configured to function as a soft AP. Such functionality can fall to the playback device that is receiving the BLUETOOTH audio stream from the external device such as a smartphone. As such, if the external device begins streaming the audio stream to a new playback device, the soft AP functionality can also shift to that new playback device and a new wireless network can be created and hosted by the new playback device.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular feature, structure, or characteristic described in connection with the embodiment can be included in at least one example embodiment. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### VII. Example Features

(Feature 1) A first playback device comprising: one or more processors; an audio output interface operably connected to the one or more processors and configured to output audio; one or more communication interfaces operably connected to the one or more processors and configured to facilitate communication over at least one network; a tangible, non-transitory computer-readable memory operably connected to the one or more processors; and program instructions stored on the tangible, non-transitory computer-readable memory, wherein the program instructions are executable by the one or more processors such that the first playback device is configured to: receive an audio stream via a first wireless network; play back, via the audio output interface, audio content based on the audio stream; while receiving the audio stream via the first wireless network, transmit an indication of availability of the audio stream; detect a request, from a second playback device, to play back the audio stream; establish a second wireless network; detect that the second playback device has joined the second wireless network; and transmit the audio stream to the second playback device via the second wireless network.

(Feature 2) The first playback device of feature 1, wherein the program instructions to establish the second wireless network comprise program instructions that are executable by the one or more processors such that the first playback device is configured to establish the second wireless network after receipt of the request from the second playback device to play back the audio stream.

(Feature 3) The first playback device of either feature 1 or feature 2, wherein the program instructions to transmit the audio stream to the second playback device via the second wireless network comprise program instructions that are executable by the one or more processors such that the first playback device is configured to cause synchronous playback of the audio content based on the audio stream on both the first playback device and the second playback device.

(Feature 4) The first playback device of any of features 1-3, wherein the program instructions further comprise instructions that are executable by the one or more processors such that the first playback device is configured to: detect a first response to the indication of availability of the audio stream; establish the second wireless network such that the first playback device is operating as a network access point; and operably connect to the second playback device via the second wireless network.

(Feature 5) The first playback device of feature 4, wherein the program instructions further comprise instructions that are executable by the one or more processors such that the first playback device is configured to: detect a second response to the indication of availability of the audio stream; operably connect to a third playback device via the second wireless network; and transmit the audio stream to the third playback device via the second wireless network.

(Feature 6) The first playback device of feature 5, wherein the program instructions to transmit the audio stream to the third playback device via the second wireless network comprise program instructions that are executable by the one or more processors such that the first playback device is configured to cause synchronous playback of the audio content based on the audio stream on both the first playback device and the third playback device.

(Feature 7) The first playback device of any of features 1-6, wherein the program instructions to transmit the indication of availability of the audio stream further comprise instructions that are executable by the one or more processors such that the first playback device is configured to transmit the indication of availability of the audio stream and an indication that the first playback device is operating as a network access point.

(Feature 8) The first playback device of feature 7, wherein the program instructions further comprise instructions that are executable by the one or more processors such that the first playback device is configured to: detect when the second playback device has left the second wireless network; after an elapsed period of time, turn off functionality associated with the network access point at the first playback device; and indicate that the first playback device is no longer operating as the network access point.

(Feature 9) The first playback device of any of features 1-8, further comprising a physical interface integrated into a housing of the first playback device and operably connected to the one or more processors, wherein the physical interface is configured to detect user input, the physical interface comprising at least one push-button and at least one visual indicator.

(Feature 10) The first playback device of feature 9, wherein the program instructions further comprise instructions that are executable by the one or more processors such that the first playback device is configured to: detect a first user input at the physical interface, wherein the first user input comprises a first push and hold input to the at least one push-button; establish, in response to the first user input, the second wireless network such that the first playback device is operating as a network access point; and update the indication of availability of the audio stream to indicate that the first playback device is operating as the network access point.

(Feature 11) The first playback device of feature 10, wherein the program instructions further comprise instructions that are executable by the one or more processors such that the first playback device is configured to update an output of the at least one visual indicator to provide an indication that the first playback device is operating as the network access point.

(Feature 12) The first playback device of either feature 10 or feature 11, wherein the program instructions further comprise instructions that are executable by the one or more processors such that the first playback device is configured to: detect a second user input at the physical interface, wherein the second user input comprises a second push and hold input to the at least one push-button; turn off, in response to the second user input, the second wireless network; and update the indication of availability of the audio stream to indicate that the first playback device is no longer operating as the network access point.

(Feature 13) The first playback device of feature 12, wherein the program instructions further comprise instructions that are executable by the one or more processors such that the first playback device is configured to update the output of the at least one visual indicator to provide an indication that the first playback device is no longer operating as the network access point.

(Feature 14) The first playback device of any of features 1-13, wherein the first wireless network is a BLUETOOTH network established between the first playback device and an external device initially transmitting the audio stream.

(Feature 15) The first playback device of any of features 1-14, wherein the second wireless network comprises an 802.11 network.

(Feature 16) The first playback device of feature 15, wherein the 802.11 network comprises one or more of a 2.4 GHz wireless network or a 5.0 GHz wireless network.

(Feature 17) The first playback device of any of features 1-16, wherein the second wireless network comprises one or more of a WIFI network, a BLUETOOTH network, a Z-Wave network, or a ZIGBEE network.

(Feature 18) The first playback device of any of features 1-17, wherein the program instructions further comprise instructions that are executable by the one or more processors such that the first playback device is configured to transmit the indication of availability of the audio stream as a BLUETOOTH LOW ENERGY message.

(Feature 19) A method comprising: receiving, from an external device, an audio stream at a first playback device via a first wireless network; playing back an audio output via an audio output interface at the first playback device, the audio output based on the audio stream; transmitting, by the first playback device, an indication of availability of the audio stream; detecting, by the first playback device, a request from a second playback device to play back the audio stream; establishing, by the first playback device, a second wireless network; detecting, by the first playback device, that the second playback device has joined the second wireless network; and transmitting, by the first playback device, the audio stream to the second playback device via the second wireless network.

(Feature 20) The method of feature 19, wherein establishing the second wireless network comprises establishing the second wireless network in response to detecting the request from the second playback device to play back the audio stream.

(Feature 21) The method of feature 19 or feature 20, wherein transmitting the audio stream to the second playback device via the second wireless network comprises causing synchronous playback of the audio output based on the audio stream on both the first playback device and the second playback device.

(Feature 22) The method of any of features 19-21, further comprising: detecting, by the first playback device, a first response to the indication of availability of the audio stream from the second playback device; establishing the second wireless network such that the first playback device is operating as a network access point; and operably connecting, by the first playback device, to the second playback device via the second wireless network.

(Feature 23) The method of feature 22, further comprising: detecting, by the first playback device, a second response to the indication of availability of the audio stream from a third playback device; operably connecting, by the first playback device, to the third playback device via the second wireless network; and transmitting the audio stream from the first playback device to the third playback device via the second wireless network.

(Feature 24) The method of feature 23, wherein transmitting the audio stream from the first playback device to the third playback device via the second wireless network comprises causing synchronous playback of the audio output based on the audio stream on both the first playback device and the third playback device.

(Feature 25) The method of any of features 19-24, wherein transmitting the indication of availability of the audio stream further comprises transmitting the indication of availability of the audio stream and an indication that the first playback device is operating as a network access point.

(Feature 26) The method of feature 25, further comprising: detecting, by the first playback device, when the second playback device leaves the second wireless network; after an elapsed period of time, turning off functionality associated with the network access point at the first playback device; and indicating that the first playback device is no longer operating as the network access point.

(Feature 27) The method of any of features 19-26, further comprising detecting, at a physical interface of the first playback device comprising at least one push-button and at least one visual indicator, at least one user input.

(Feature 28) The method of feature 27, further comprising: detecting a first user input at the physical interface, wherein the first user input comprises a first push and hold input to the at least one push-button; establishing, in response to the first user input, the second wireless network such that the first playback device is operating as a network access point; and updating the indication of availability of the audio stream to indicate that the first playback device is operating as the network access point.

(Feature 29) The method of feature 28, further comprising updating an output of the at least one visual indicator to provide an indication that the first playback device is operating as the network access point.

(Feature 30) The method of feature 28 or feature 29, further comprising: detecting a second user input at the physical interface, wherein the second user input comprises a second push and hold input to the at least one push-button; turning off, in response to the second user input, the second wireless network; and updating the indication of availability of the audio stream to indicate that the first playback device is no longer operating as the network access point.

(Feature 31) The method of feature 30, further comprising updating an output of the at least one visual indicator to provide an indication that the first playback device is no longer operating as the network access point.

(Feature 32) The method of any of features 19-31, wherein receiving the audio stream at the first playback device via the first wireless network comprises receiving the audio stream at the first playback device via a BLUETOOTH connection established between the first playback device and the external device.

(Feature 33) The method of any of features 19-32, wherein receiving the audio stream at the first playback device via the first wireless network comprises receiving the audio stream at the first playback device via an 802.11 network connection between the first playback device and the second playback device.

(Feature 34) The method of feature 33, wherein receiving the audio stream at the first playback device via the 802.11 network connection between the first playback device and the second playback device comprises receiving the audio stream at the first playback device via one or more of a 2.4 GHz wireless connection between the first playback device and the second playback device and a 5.0 GHz wireless connection between the first playback device and the second playback device.

(Feature 35) The method of any of features 19-34, wherein receiving the audio stream at the first playback device via the first wireless network comprises receiving the audio stream at the first playback device via a WIFI connection between the first playback device and the second playback device.

(Feature 36) The method of any of features 19-35, wherein transmitting the indication of availability of the audio stream comprises transmitting a BLUETOOTH LOW ENERGY message.

(Feature 37) A media playback system comprising: a first playback device comprising: one or more first processors; a first audio output interface operably connected to the one or more first processors and configured to output first audio; one or more first communication interfaces operably connected to the one or more first processors and configured to facilitate communication over at least one network; a first tangible, non-transitory computer-readable memory operably connected to the one or more first processors; and first program instructions stored on the first tangible, non-transitory computer-readable memory, wherein the first program instructions are executable by the one or more first processors such that the first playback device is configured to: receive an audio stream from an external device via a first wireless network; play back, via the first audio output interface, audio content based on the audio stream; while receiving the audio stream via the first wireless network, transmit an indication of availability of the audio stream; detect a request, from a second playback device, to play back the audio stream; establish a second wireless network; detect that the second playback device has joined the second wireless network; and transmit the audio stream to the second playback device via the second wireless network; and the second playback device comprising: one or more second processors; a second audio output interface operably connected to the one or more second processors and configured to output second audio; one or more second communication interfaces operably connected to the one or more second processors and configured to facilitate communication; a second tangible, non-transitory computer-readable memory operably connected to the one or more second processors; and second program instructions stored on the second tangible, non-transitory computer-readable memory, wherein the second program instructions are executable by the one or more second processors such that the second playback device is configured to: detect the indication of availability of the audio stream from the first playback device, transmit a response to the indication of availability of the audio stream to the first playback device, join the second wireless network, and receive the audio stream from the first playback device via the second wireless network.

(Feature 38) The system of feature 37, the one or more first processors being configured to establish the second wireless network comprises the one or more first processors being configured to establish the second wireless network in response to the request.

(Feature 39) The system of either feature 37 or feature 38, the one or more first processors being configured to transmit the audio stream to the second playback device via the second wireless network comprises the one or more first processors being configured to cause synchronous playback of the audio content corresponding to the received audio stream on both the first playback device and the second playback device.

(Feature 40) The system of any of features 37-39, wherein the one or more first processors are further configured to: detect the response to the indication of availability of the audio stream transmitted from the second playback device; establish the second wireless network such that the first playback device is operating as a network access point; and connect to the second playback device via the second wireless network.

(Feature 41) The system of any of features 37-40, the one or more first processors being configured to transmit the indication of availability of the audio stream comprises the one or more first processors being configured to transmit an indication of availability of the audio stream and an indication that the first playback device is operating as a network access point.

(Feature 42) The system of feature 41, wherein the one or more first processors are configured to: detect when the second playback device has left the second wireless network; after an elapsed period of time, turn off functionality associated with the network access point at the first playback device; and indicate that the first playback device is no longer operating as the network access point.

(Feature 43) The system of any of features 37-42, wherein the first wireless network comprises a BLUETOOTH network established between the first playback device and the external device.

(Feature 44) The system of any of features 37-43, wherein the second wireless network comprises an 802.11 network connection.

(Feature 45) The system of feature 44, wherein the 802.11 network connection comprises one or more of a 2.4 GHz wireless connection and a 5.0 GHz wireless connection.

(Feature 46) The system of any of features 37-45, wherein the second wireless network comprises one or more of a WIFI network, a BLUETOOTH network, a Z-Wave network, or a ZIGBEE network.

(Feature 47) The system of any of features 37-46, the one or more first processors being configured to transmit the indication of availability of the audio stream as a BLUETOOTH LOW ENERGY message.

(Feature 48) The system of any of features 37-47, wherein the indication of availability of the audio stream includes a time stamp specifying a time at which the first playback device played back the audio content.

1. A first playback device comprising:
one or more processors;
an audio output interface operably connected to the one or more processors and configured to output audio;
one or more communication interfaces operably connected to the one or more processors and configured to facilitate communication over at least one network;
a tangible, non-transitory computer-readable memory operably connected to the one or more processors; and
program instructions stored on the tangible, non-transitory computer-readable memory, wherein the program instructions are executable by the one or more processors such that the first playback device is configured to:
receive an audio stream via a first wireless network;
play back, via the audio output interface, audio content based on the audio stream;
while receiving the audio stream via the first wireless network, transmit an indication of availability of the audio stream;
detect a request, from a second playback device, to play back the audio stream;
establish a second wireless network;
detect that the second playback device has joined the second wireless network; and
transmit the audio stream to the second playback device via the second wireless network.

2. The first playback device of claim 1, wherein the program instructions to establish the second wireless network comprise program instructions that are executable by the one or more processors such that the first playback device is configured to establish the second wireless network after receipt of the request from the second playback device to play back the audio stream.

3. The first playback device of claim 1, wherein the program instructions to transmit the audio stream to the second playback device via the second wireless network comprise program instructions that are executable by the one or more processors such that the first playback device is configured to cause synchronous playback of the audio content based on the audio stream on both the first playback device and the second playback device.

4. The first playback device of claim 1, wherein the program instructions further comprise instructions that are executable by the one or more processors such that the first playback device is configured to:
detect a first response to the indication of availability of the audio stream;
establish the second wireless network such that the first playback device is operating as a network access point;
operably connect to the second playback device via the second wireless network;
detect a second response to the indication of availability of the audio stream;
operably connect to a third playback device via the second wireless network; and
transmit the audio stream to the third playback device via the second wireless network.

5. The first playback device of claim 4, wherein the program instructions to transmit the audio stream to the third playback device via the second wireless network comprise program instructions that are executable by the one or more processors such that the first playback device is configured to cause synchronous playback of the audio content based on the audio stream on both the first playback device and the third playback device.

6. The first playback device of claim 1, further comprising a physical interface integrated into a housing of the first playback device and operably connected to the one or more processors, wherein the physical interface is configured to detect user input, the physical interface comprising at least one push-button and at least one visual indicator, and wherein the program instructions further comprise instructions that are executable by the one or more processors such that the first playback device is configured to:
detect a first user input at the physical interface, wherein the first user input comprises a first push and hold input to the at least one push-button;
establish, in response to the first user input, the second wireless network such that the first playback device is operating as a network access point; and
update the indication of availability of the audio stream to indicate that the first playback device is operating as the network access point.

7. The first playback device of claim 6, wherein the program instructions further comprise instructions that are executable by the one or more processors such that the first playback device is configured to update an output of the at least one visual indicator to provide an indication that the first playback device is operating as the network access point.

8. The first playback device of claim 6, wherein the program instructions further comprise instructions that are executable by the one or more processors such that the first playback device is configured to:
detect a second user input at the physical interface, wherein the second user input comprises a second push and hold input to the at least one push-button;
turn off, in response to the second user input, the second wireless network; and
update the indication of availability of the audio stream to indicate that the first playback device is no longer operating as the network access point.

9. The first playback device of claim 8, wherein the program instructions further comprise instructions that are executable by the one or more processors such that the first playback device is configured to update an output of the at least one visual indicator to provide an indication that the first playback device is no longer operating as the network access point.

10. The first playback device of claim 1, wherein the second wireless network comprises an 802.11 network.

11. The first playback device of claim 10, wherein the 802.11 network comprises one or more of a 2.4 GHz wireless network and a 5.0 GHz wireless network.

12. The first playback device of claim 1, wherein the second wireless network comprises one or more of a WIFI network, a BLUETOOTH network, a Z-Wave network, or a ZIGBEE network.

13. A method comprising:
receiving, from an external device, an audio stream at a first playback device via a first wireless network;
playing back an audio output via an audio output interface at the first playback device, the audio output based on the audio stream;
transmitting, by the first playback device, an indication of availability of the audio stream;
detecting, by the first playback device, a request from a second playback device to play back the audio stream;
establishing, by the first playback device, a second wireless network;
detecting, by the first playback device, that the second playback device has joined the second wireless network; and
transmitting, by the first playback device, the audio stream to the second playback device via the second wireless network.

14. The method of claim 13, further comprising:
detecting, by the first playback device, a first response to the indication of availability of the audio stream from the second playback device;
establishing the second wireless network such that the first playback device is operating as a network access point; and
operably connecting, by the first playback device, to the second playback device via the second wireless network.

15. The method of claim 13, wherein transmitting the indication of availability of the audio stream further comprises transmitting the indication of availability of the audio stream and an indication that the first playback device is operating as a network access point, and wherein the method further comprises:
detecting, by the first playback device, when the second playback device leaves the second wireless network;
after an elapsed period of time, turning off functionality associated with the network access point at the first playback device; and
indicating that the first playback device is no longer operating as the network access point.

16. The method of claim 13, further comprising detecting, at a physical interface of the first playback device comprising at least one push-button and at least one visual indicator, at least one user input.

17. A media playback system comprising:
a first playback device comprising:
one or more first processors;
a first audio output interface operably connected to the one or more first processors and configured to output first audio;
one or more first communication interfaces operably connected to the one or more first processors and configured to facilitate communication over at least one network;
a first tangible, non-transitory computer-readable memory operably connected to the one or more first processors; and
first program instructions stored on the first tangible, non-transitory computer-readable memory, wherein the first program instructions are executable by the one or more first processors such that the first playback device is configured to:
receive an audio stream from an external device via a first wireless network;
play back, via the first audio output interface, audio content based on the audio stream;
while receiving the audio stream via the first wireless network, transmit an indication of availability of the audio stream;
detect a request, from a second playback device, to play back the audio stream;
establish a second wireless network;
detect that the second playback device has joined the second wireless network; and
transmit the audio stream to the second playback device via the second wireless network; and
the second playback device comprising:
one or more second processors;
a second audio output interface operably connected to the one or more second processors and configured to output second audio;
one or more second communication interfaces operably connected to the one or more second processors and configured to facilitate communication;
a second tangible, non-transitory computer-readable memory operably connected to the one or more second processors; and
second program instructions stored on the second tangible, non-transitory computer-readable memory, wherein the second program instructions are executable by the one or more second processors such that the second playback device is configured to:
detect the indication of availability of the audio stream from the first playback device,
transmit a response to the indication of availability of the audio stream to the first playback device,
join the second wireless network, and
receive the audio stream from the first playback device via the second wireless network.

18. The system of claim 17, wherein the indication of availability of the audio stream includes a time stamp specifying a time at which the first playback device played back the audio content.

19. The system of claim 17, wherein the first wireless network comprises a BLUETOOTH network established between the first playback device and the external device.

20. The system of claim 17, the one or more first processors being configured to transmit the indication of availability of the audio stream as a BLUETOOTH LOW ENERGY message.
